(19) United States
(12) Patent Application Publication
(10) Pub. No.: US 2014/0006858 A1
(43) Pub. Date: Jan. 2, 2014

(54) UNIVERSAL PLUGGABLE CLOUD DISASTER RECOVERY SYSTEM

(71) Applicants: Noam Sid Helfman, Redmond, WA (US); Ken Hines, Kenmore, WA (US); Reid Andrew Spencer, Mercer Island, WA (US); Moshe Vainer, Redmond, WA (US); Kalpana Narayanaswamy, Redmond, WA (US); Przemyslaw Pardyak, Seattle, WA (US); Ashutosh Tiwary, Bellevue, WA (US)

(72) Inventors: Noam Sid Helfman, Redmond, WA (US); Ken Hines, Kenmore, WA (US); Reid Andrew Spencer, Mercer Island, WA (US); Moshe Vainer, Redmond, WA (US); Kalpana Narayanaswamy, Redmond, WA (US); Przemyslaw Pardyak, Seattle, WA (US); Ashutosh Tiwary, Bellevue, WA (US)

(21) Appl. No.: 13/706,198

(22) Filed: Dec. 5, 2012

Related U.S. Application Data
(60) Provisional application No. 61/567,029, filed on Dec. 5, 2011.

(51) Int. Cl. G06F 11/14

(52) U.S. Cl. CPC G06F 11/1448
USPC 714/19

(57) ABSTRACT

A method, implementable in a system coupled to a display device and a network, includes generating in a first region of a screen of the display device a user-interface portion associated with a first electronic destination address. The user-interface portion is configured to receive from a second region of the screen, in response to a command by a user of the system, a first icon representing a data set. In response to the user-interface portion receiving the first icon, a copy of the data set, or the data set itself, is electronically transferred over the network to the first destination address.

### CROSS-REFERENCE TO RELATED APPLICATIONS

This application claims priority to U.S. Provisional Appl. No. 61/567,029 filed Dec. 5, 2011, which is hereby incorporated by reference in its entirety.

### BACKGROUND OF THE INVENTION

An embodiment relates generally to computer-implemented processes.

### BRIEF DESCRIPTION OF THE SEVERAL VIEWS OF THE DRAWING

Preferred and alternative embodiments of the present invention are described in detail below with reference to the following drawings.

FIGS. 1-15 illustrate elements and/or principles of at least one embodiment of the invention.

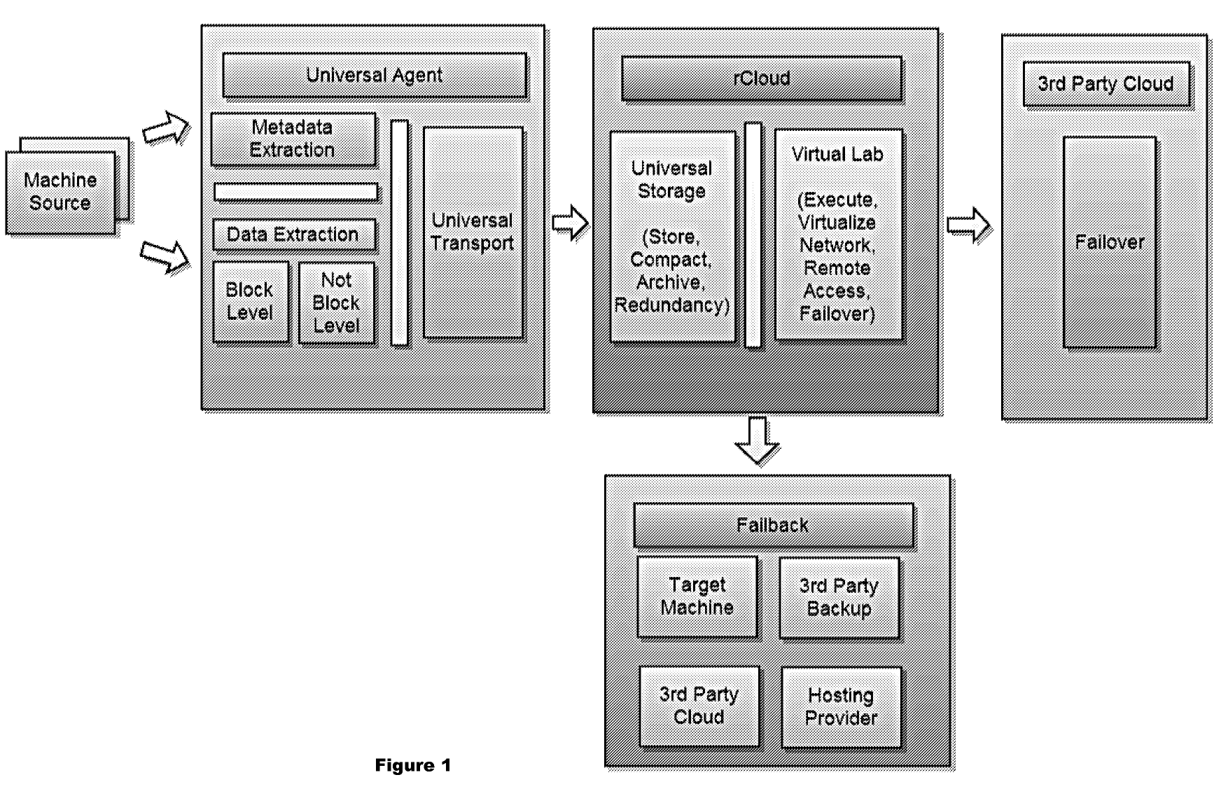

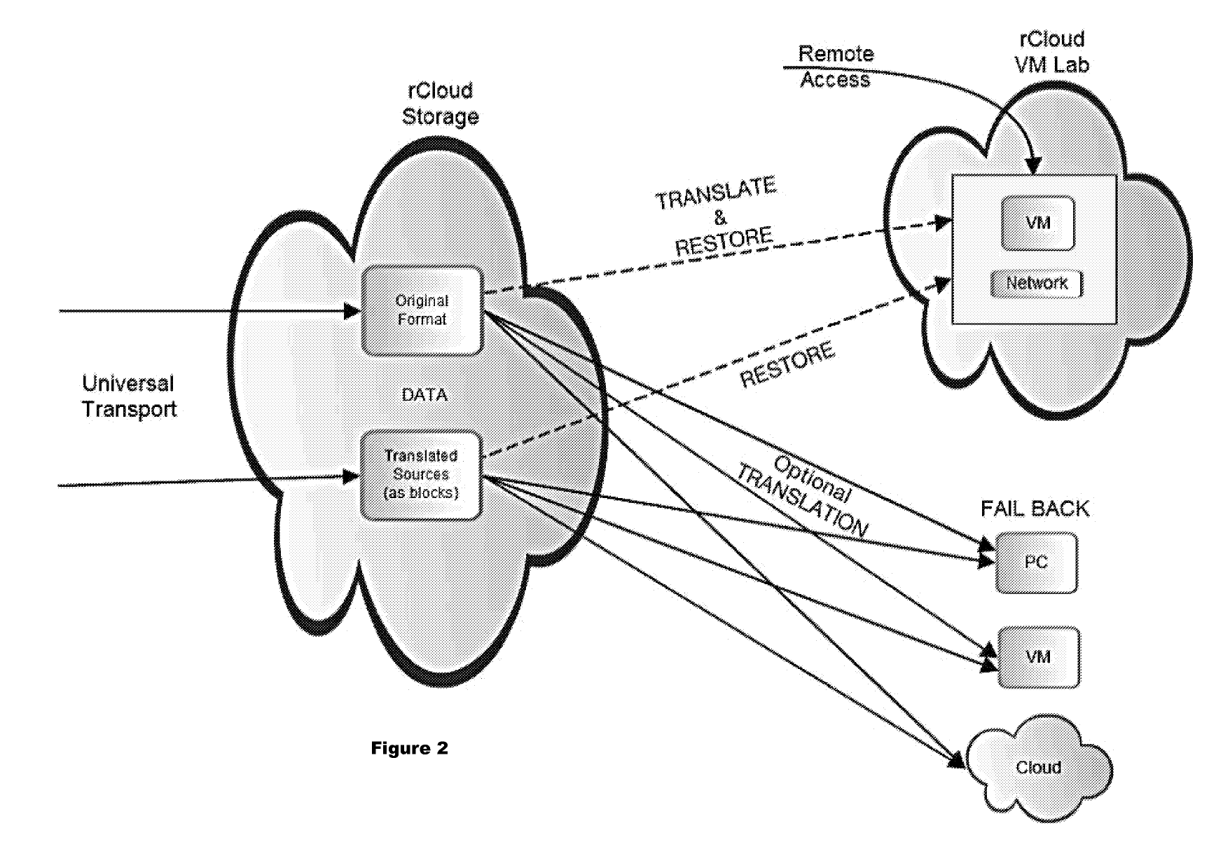

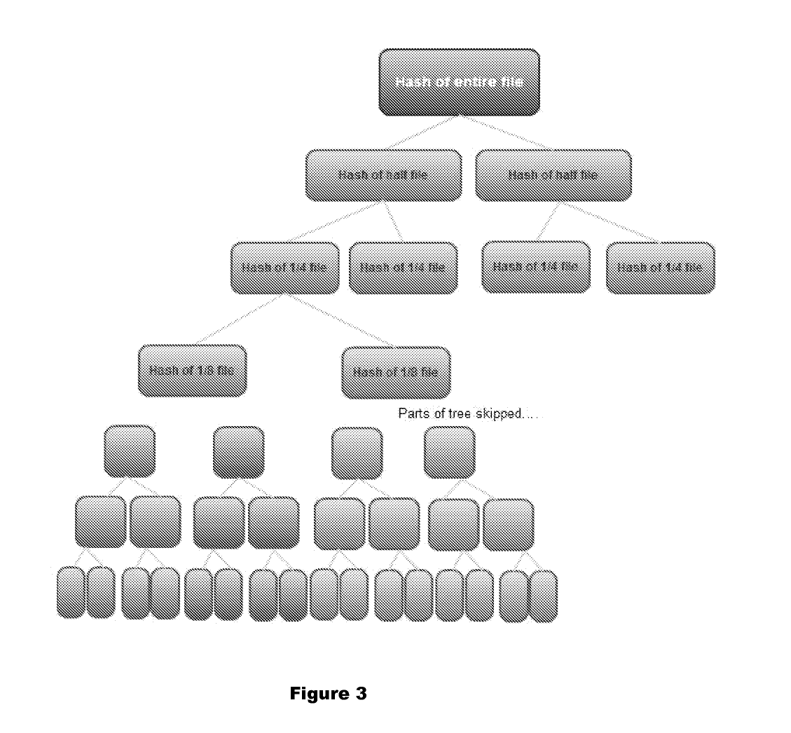

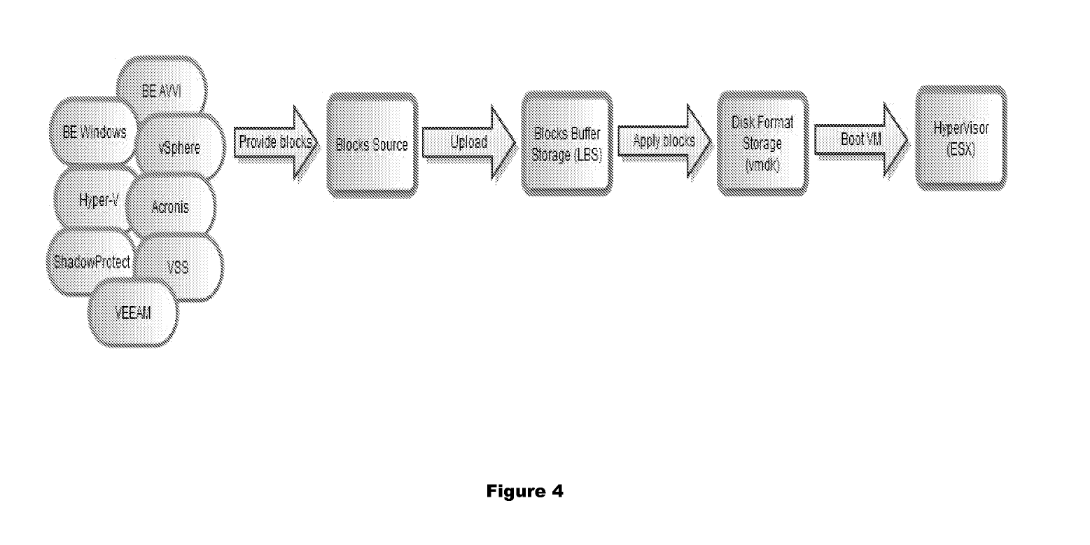

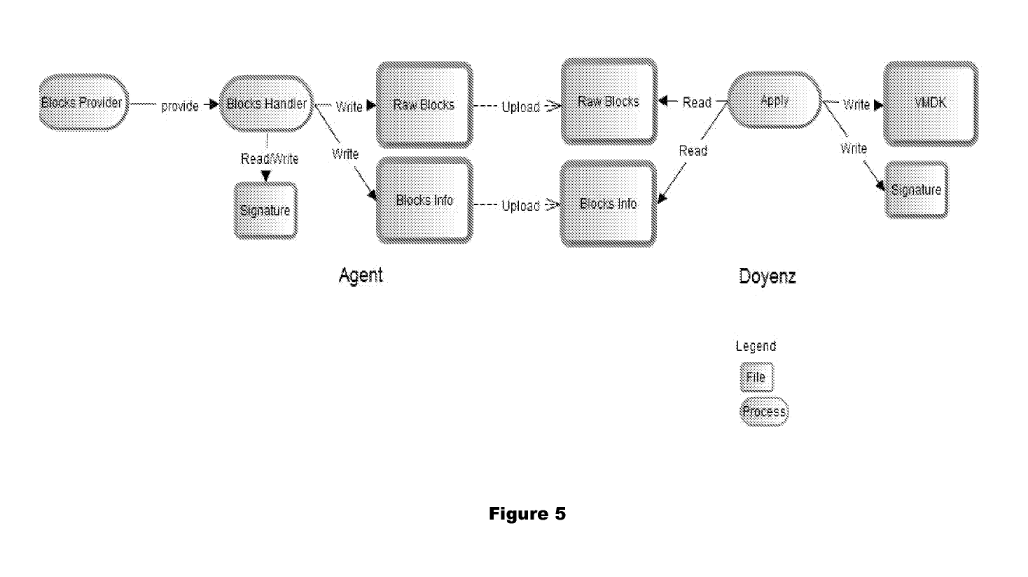

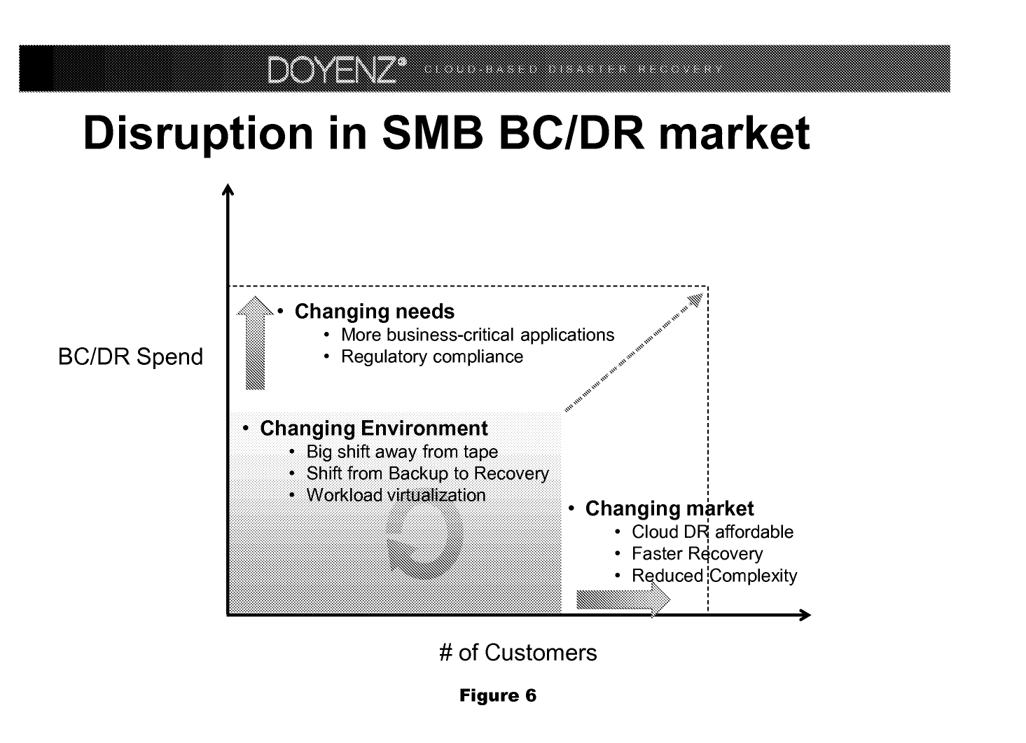

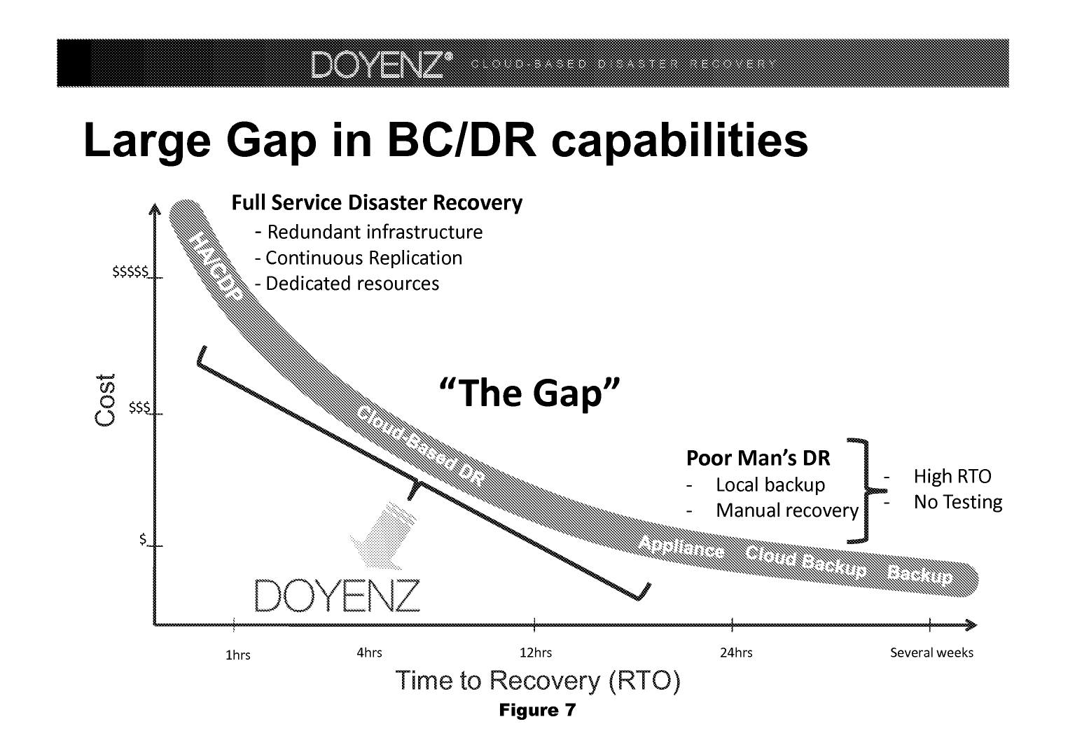

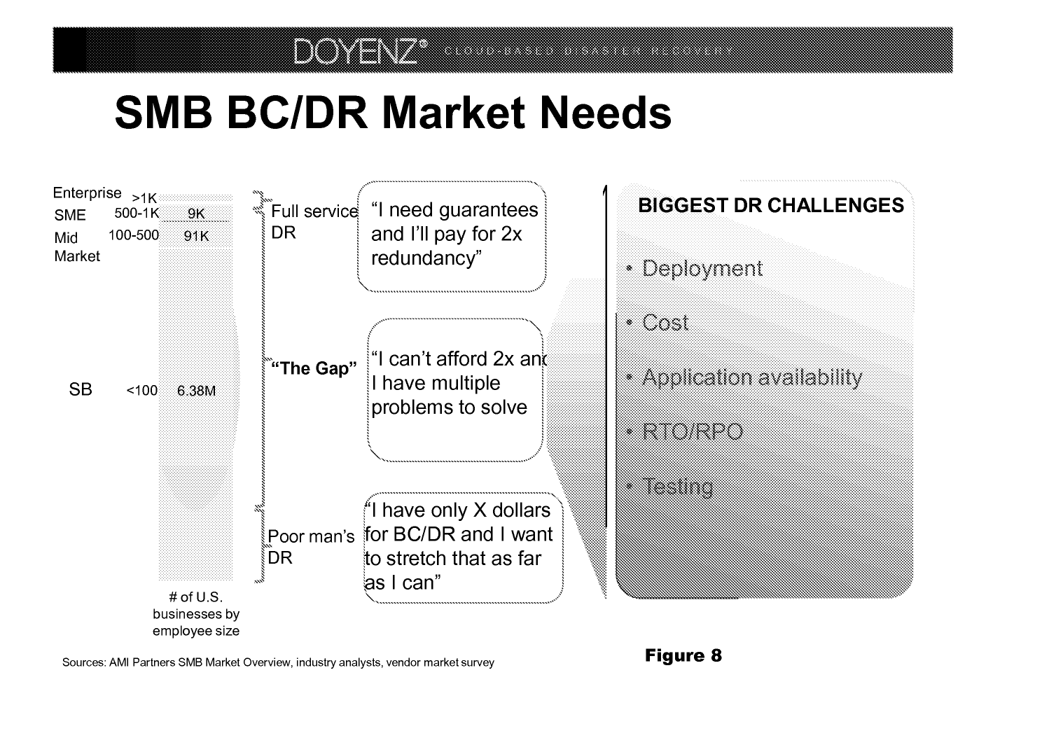

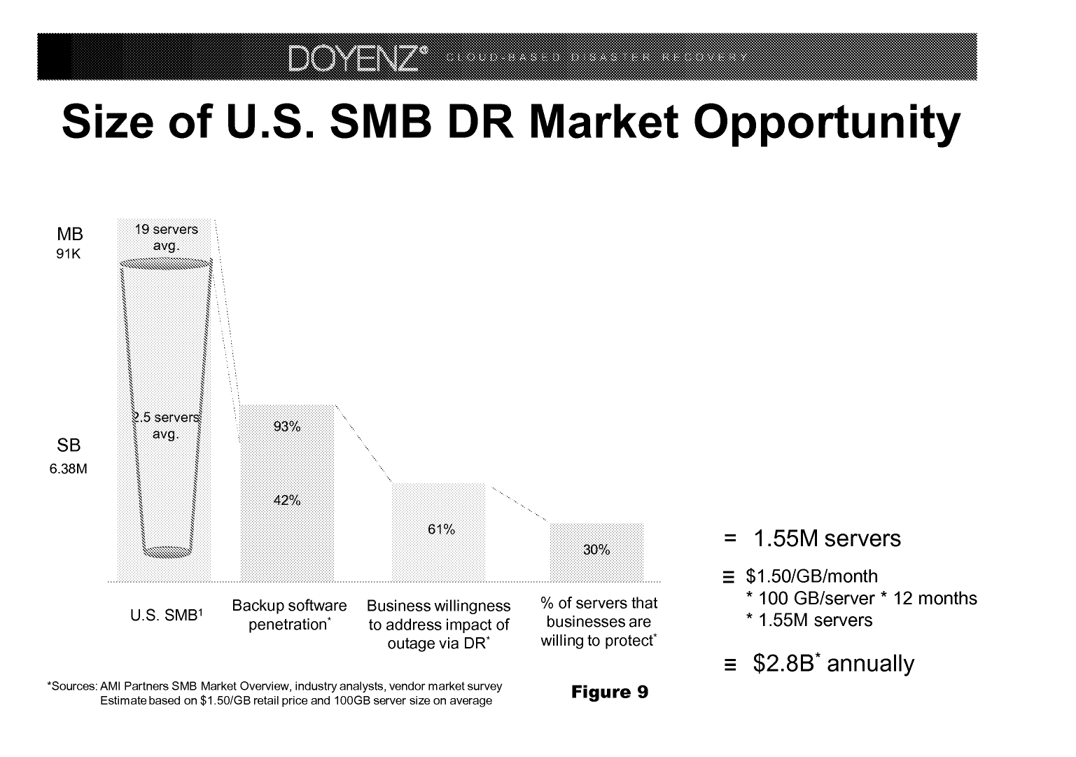

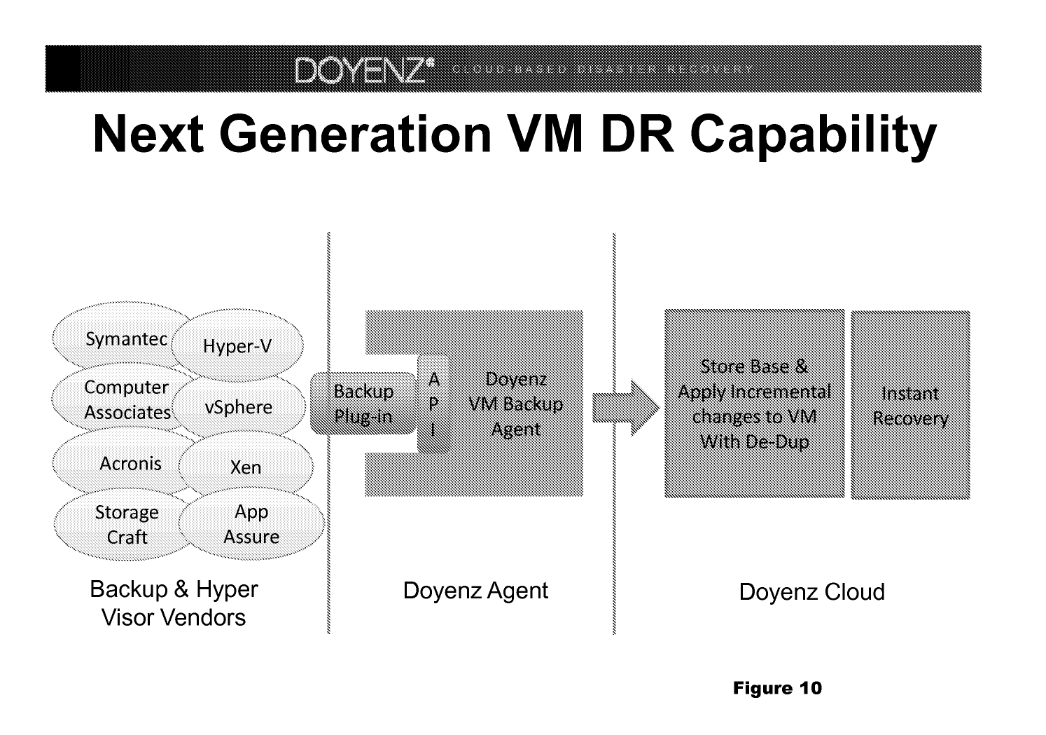

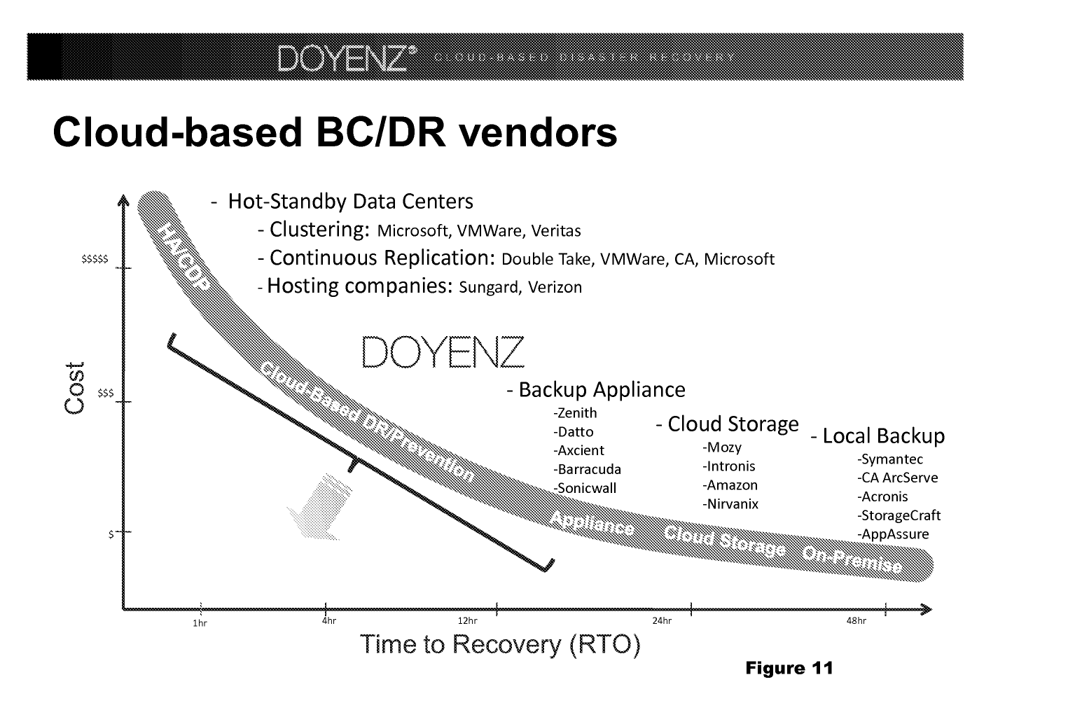

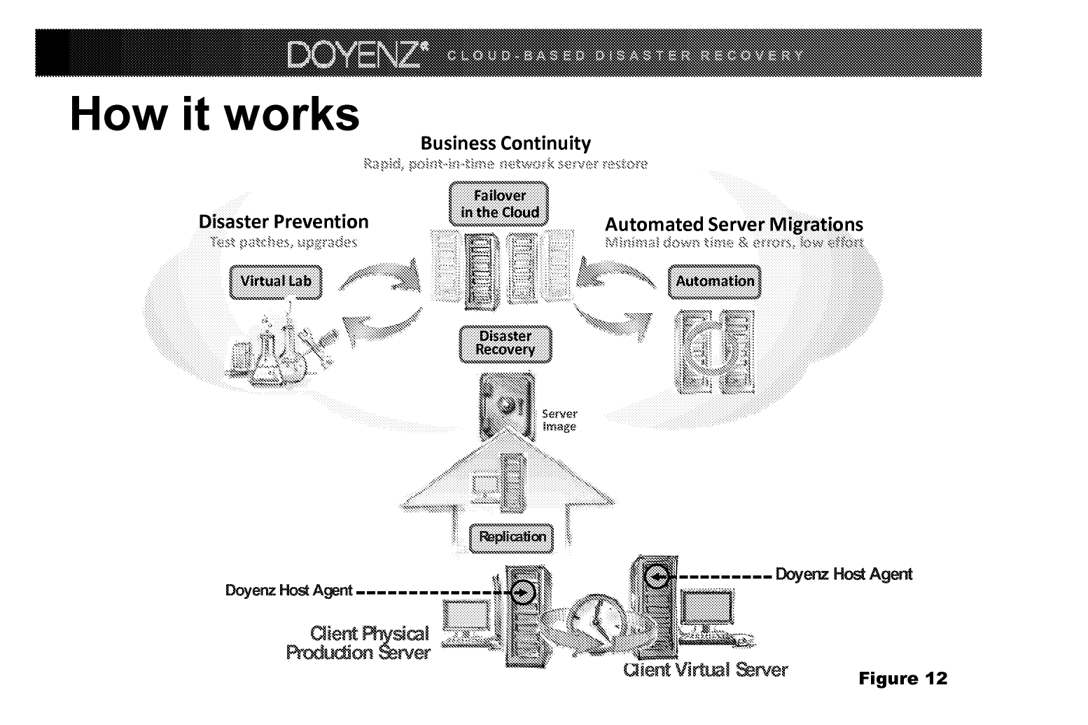

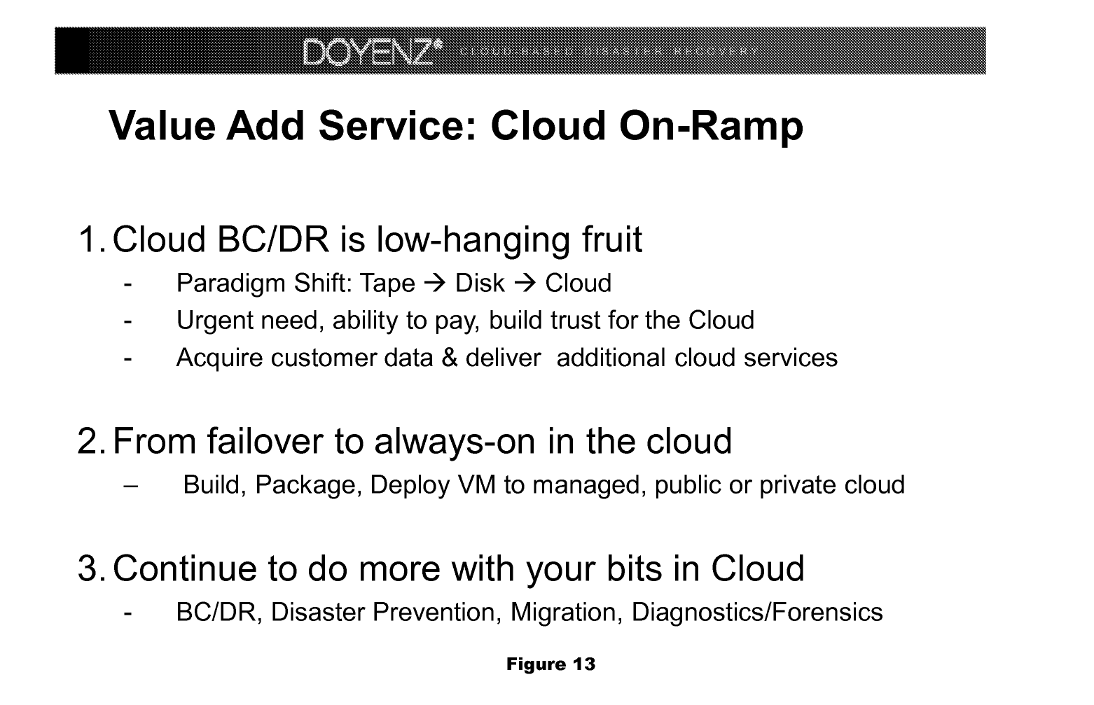

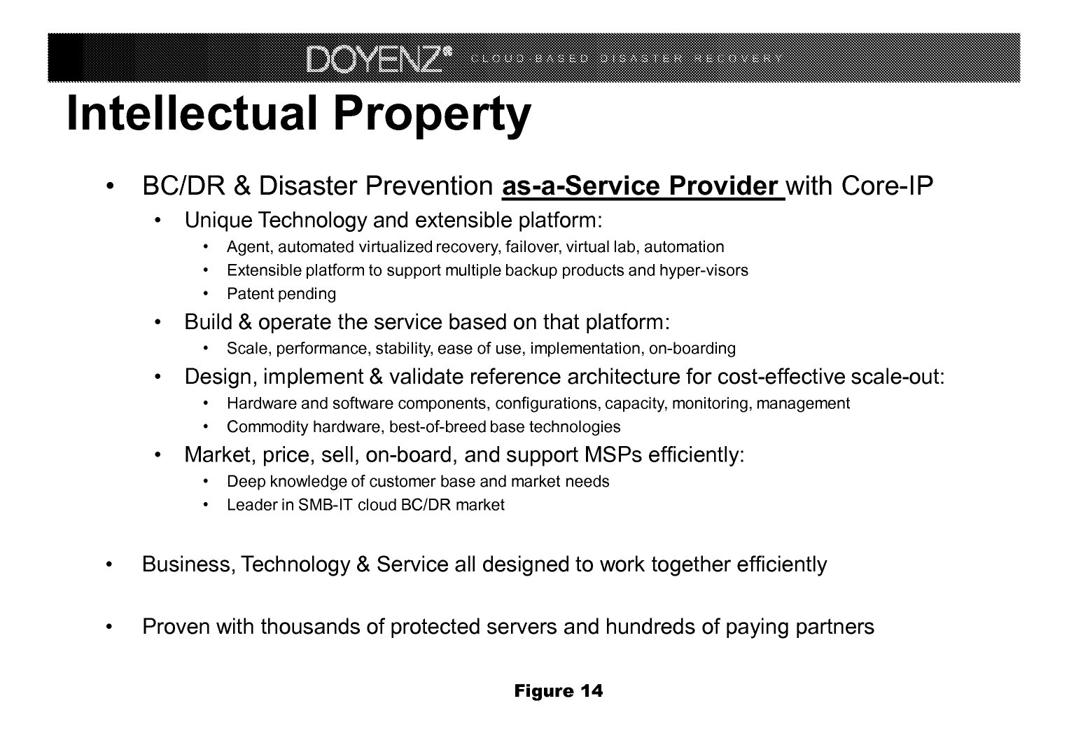

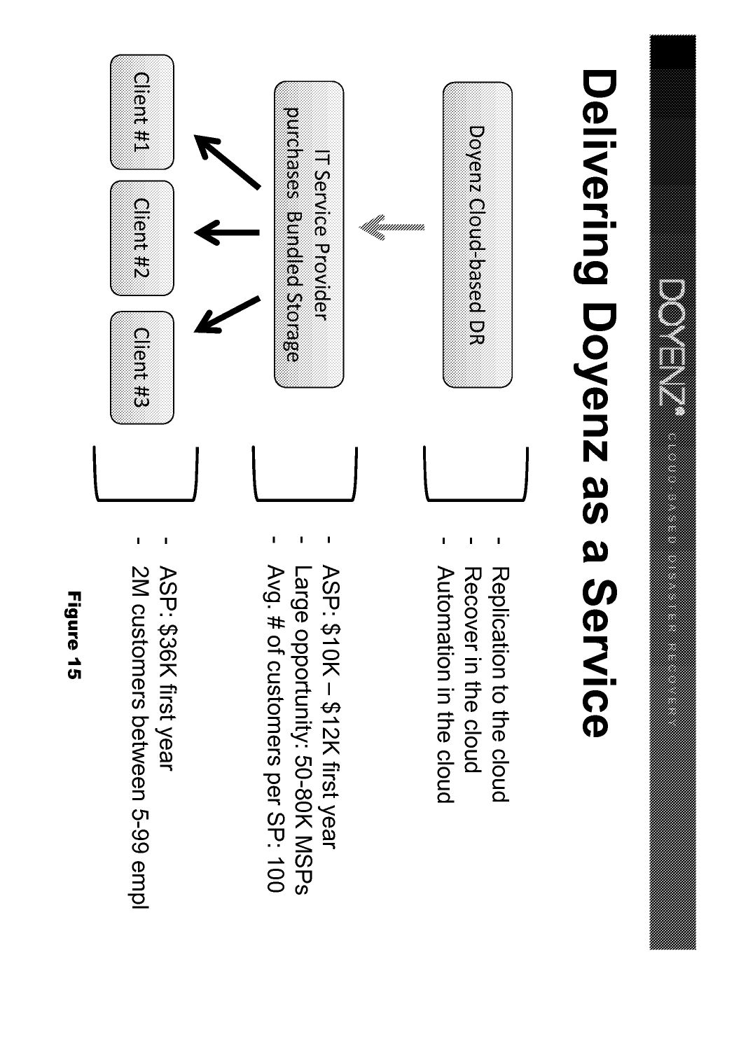

### DETAILED DESCRIPTION OF THE INVENTION

This patent application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

Embodiments of the invention may be operational with numerous general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Embodiments of the invention may be described in the general context of computer-executable instructions, such as program modules, being executed by a computer and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Embodiments of the invention may include or be implemented in a variety of computer readable media. Computer readable media can be any available media that can be accessed by a computer and includes both volatile and nonvolatile media, removable and non-removable media. By way of example, and not limitation, computer readable media may comprise computer storage media and communication media. Computer storage media include volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

Embodiments of the invention may be referred to herein using the term “Doyenz rCloud.” Doyenz rCloud universal disaster recovery system utilizes a fully decoupled architecture to allow backups or capture of different types of data, e.g., files, or machines, using different sources and source mechanisms of the data, and to restore them into different types of data, e.g., files, or machines, using different targets and target mechanisms for the data. rCloud may use different types of transfer, transformation, or storage mechanisms to facilitate the process.

As applied to disaster recovery, rCloud may include but is not limited to the following functionality and application:

Support for multiple sources and formats of data, including but not limited to files, disks, blocks, backups, virtual machines and changes to all of them,

Sources may include but are not limited to full, incremental, and other forms of backups that are made at any possible level, including but not limited to, at a file level, block level, image level, application level, service level, mailbox level, etc and may come from or be related to, directly or indirectly, to any operating system, hypervisor, networking environment, or other implementation or configuration, etc.

These sources can reside on different types of media, including but not limited to disk, tape, cloud, on-premise etc,

A simple pluggable universal agent that allows Doyenz or a third party to build a provider for each source of data for a given source solution that allows us to consume that data,

The consumed data may be transported via the universal transport mechanism to the cloud where it could be (i) either stored as the source and/or incremental change, (ii) applied to a stored instance, (iii) applied to a running instance at any given point in time

An universal restore mechanism that can take the changes, apply them to the appropriate source data in the cloud and enable rapid recovery, including but not limited to machine and file level backup restore, direct replication to a live instance of the data or machine, etc.

The recovery can be used for failover, DR testing and other forms of production testing scenario

This approach allows the ability to provide a cloud-based recovery service to a much larger portion of the market segment.

While the language in this document uses Disaster Recovery, backups, uploads and cloud as specific examples, it applies equally to any system where different types of data or machines are transferred between any number of sources and targets of different types, for example, digital media instead of machine backups, or two workgroup networks within the same IT organization instead of local hosts and cloud providers.

Examples, of source and target data include physical machines, virtual machines for different hypervisors or different cloud providers, files of different types, other data of different types, backups of either physical or virtual machines or files or other date provided by backup software or other means. Source and target data may be stored on or transferred through any media.

Any word such as machine, virtual machine, physical machine, VM, backup, instance, server, workstation, computer, storage, system, data, media, database, file, disk, drive, block, application data, application, raw blocks, running machine, live machine, live data, or other similar or equivalent terms may be used interchangeably to mean either source or target or intermediate stage or representation data within the system.

Any word such as backup, import, seeding, restore, recover, capture, extract, save, store, reading, writing, ingress, egress, mirroring, copying, live data updated, continues data protection, or other similar or equivalent terms may be used interchangeably to mean adding of data into the system, moving it outside of the system, its internal transfer, representation, transformation, or other usage or representation.

Any reference to block-based mechanism, operation, or system, or similar or equivalent may be used interchangeably to mean any of the following or their combination: fixed sized block based, flexible sized block based, non block based, stream based, or other form of representation, transfer, operation, transformation, or other as applicable in the context it is used.

Any reference to block is equivalent to data, data set, subset of data, fragment of data, representation of data, or other as applicable in the context it is used.

Any reference to cloud, rCloud, system, product, Doyenz, mechanism, service, services, invention, implementation, architecture, solution, software, backend, frontend, agent, sender, receiver or other similar or equivalent term may be used interchangeably to refer to overall system and set of mechanisms being described. Doyenz rCloud may include the following functionality in its implementation:

Read or write data

Read or write metadata

Discover sources, targets, their configuration, other relevant configuration, including but not limited to networking configuration

Transport mechanism of metadata, data, and configurations

Machine execution, including but not limited to rCloud or 3^{rd} party cloud environments, different hypervisors or other virtualization platforms, or physical machines.

Data consumption, playback, or any other form of utilization.

Backups of data, machine, media, file, database, mailbox, etc

Restore of data, machine, media, file, database, mailbox, etc

Failover of machine, service, environment, network, etc.

Failback of machine, service, environment, network, etc.

Networking, virtualized or other

Remote and local access

Storage, with optional provisions, for example, for compaction, archiving, redundancy, etc.

Transformation, including but not limited to compression, encryption, deduplication.

Conversion among different formats, including but not limited to backup software backup file formats

Maintain and use multiple versions with ability to select, delete, and use for other purposes.

Maintain and use history or logs of any operations of changes within the system, including as related to any data it maintains

Instrumentation, other form of interception, attachment, API integration, other communication, for the purpose of capturing it into the system or injecting it from the system into other systems or other purposes

Doyenz achieves flexibility by decoupling and allowing pluggable implementations that together collect and upload to the cloud info about any machine or other data itself and its configuration, including but not limited to its OS, network configuration, hardware information, disk geometry, etc, and independently allowing the translation thru utilization of plugins of block-level data from any source that represents file or block information, (see universal agent architecture), and utilizing common or specific transport of the data in to rCloud, where it is stored in the fully decoupled storage solution, thus allowing Doyenz to break the dependence between the source format, transport, storage format.

Alternatively, Doyenz stores the source data in the format it originates from (for example, local backup files stored in the cloud) and decouples the use of this data by utilization either universal restore or pluggable translation layers that translate source data in to block devices usable by decoupled hypervisors utilized by Doyenz in its rCloud solution.

When customers come to utilize their machines (e.g. in event of loss of the machine due to disaster event or hw/sw failure, virus attack, etc) stored in the rCloud, this usually means running the machine in the cloud, or failing-over machine to the cloud, or receiving the machine to customer premises, or a hosting provider of the client where the such machine will be running, or receiving the machine in format compatible with a local solution chosen by the customer, that the customer later may restore from. Since Doyenz stores one or more customer machines in the decoupled format that represents metadata about the machine(s) and format that represents customer disks that may be independent from the source format in which machine was uploaded to the cloud. Doyenz can utilize its pluggable restore architecture to construct a target machine suitable to run in Doyenz cloud or compatible to a format chosen by a customer or a format that is compatible to a 3rd party cloud, and utilizing a transport plugin to be downloaded to customer premises, or 3rd party hosting provider chosen by a customer, or 3rd party cloud, or through pluggable and decoupled Lab Manager solution run in the hypervisor of choice in Doyenz rCloud. Additionally, by utilizing decoupled network virtualization and fencing solution, Doyenz rCloud can faithfully represent a network compatible with the network described by a metadata collected from a customer by the time machine was imported or backed-up to the cloud, or a network configuration chosen by a client at the time of restore, or network configuration chosen by the client when machine is running in rCloud, or net configuration chosen by the client as a target network configuration for transporting to the 3rd party cloud, or 3rd party hosting provider, or any other place where the machine could run.

Such flexible solution or implementation, that allows any machine/source to be represented in the cloud, is called X2C (Any To Cloud).

And the solution or implementation allowing such machine representation to be executed on any target and/or transferred to any target is called C2X (Cloud To Any).

rCloud allows conversions from many formats, representations, etc. to many. For example, for backups, this may include but is not limited to

P2x—from physical to same or different form

V2x—from virtual to same or different form

C2x—from cloud to same or different form

B2x—from backup to same or different form

x2P—to physical from same or different form

x2V—to virtual from same or different form

x2C—to cloud from same or different form

x2B—to backup from same or different form

with example combinations of P2V, V2V, V2P, P2C, V2C, B2C, C2C, C2V, C2B, C2P, etc.

Blocks will be applied to a vmdk (or any disk format we would like to support) (same as storage agnostic)

Preferably, all hypervisors can encapsulate entire server or desktop environment in a file. Commonality of virtual machine disk formats enables us to support wide area of formats.

Failover to any Cloud

Doyenz's DR solution (rCloud) allows a special kind of restore—failover, where the customer's machine is made to be available and running in the cloud and accessible by the customer. rCould solution decouples backup source, storage, and virtual machine execution environment (LabManager). This approach allows Doyenz a greater flexibility of failing back to any cloud solution as a target. As a result, customer machine may start its life as physical machine, P2C to Doyenz rCloud (or any other cloud-based storage, like S3) then fail-over in to the instantly created virtual machine instance in the ESX virtualized environment as an example that Doyenz cloud currently utilizes, and then fail back to customer environment as a Hyper-V appliance (C2V) or other virtual solutions.

OS Agnostics

Doyenz's DR solution works hand-in-hand with hypervisor software and therefore any virtual machine type/OS combination that is supported by a hypervisor is also supported by our solution.

Single agent for One machine/Multiple machines/Multiple types of machines One instance of the agent is capable of handling multiple machines, both physical and virtual machines, including hypervisors. In addition, multiple physical (and virtual) machines, that are backed-up by a 3rd party standalone backup agent(s), could be handled by the same Doyenz's Agent.

Storage Agnostic

Since Doyenz's backup solution is based on storing blocks of data, we are not limited by any storage provider, it could be just a SAN storage, NAS storage, any storage cloud, distributed storage solution, technically anything that is capable of storing blocks reliably

Universal Restore

Doyenz Universal Storage stores data coming from sources can be described as belonging to at least two different types of formats—

storage formats that can be directly consumed as block based devices

other possibly proprietary storage formats that for example originate from 3rd party backup providers and are stored unchanged or modified on Doyenz storage

other formats that may be translated to and from the above

The act of restoring, failing over or otherwise executing said machines in Doyenz or third party clouds may involve one or more of the following steps:

1. Configuring a virtual or physical machine in the destination lab to conform to the metadata configuration that was captured at the time of backup and describes the source machine (e.g. amount of memory, number and type of disks, bios configuration etc. . . . )
2. Exposing the stored disk data that corresponds to the restore point in time in a format that is directly readable as disk by the target lab.
Doyenz may utilize a plug-in that is aware of the target lab api (either doyenz or third party) on one hand, and metadata format stored in doyenz on another hand, and using the target lab api can configure a virtual or physical machine that conforms to original source configuration.
Where the source data is stored on Doyenz storage as block device, the block device may be directly attached as disks to the target lab using standard lab apis and standard remote disks protocols, e.g. iSCSI, NFS, NBD etc.
Where the lab is local to doyenz, such block devices can even be represented as locally attached files, e.g. VirtualBox based lab on ZFS based storage
Where the source data is stored not as a block device, e.g., in a proprietary 3rd party format, Doyenz implements several strategies to make the source data universally accessible by the target lab including but not limited to:
1. Using original 3rd party software to perform a 3rd party restore to a destination block device—in this case the 3rd party software is either driven through an API it makes accessible or Doyenz utilizes proprietary doyenz automation (prey. patent) to functionally drive the restore process through the UI in a specially purposed virtual machine.
2. Where a 3rd party software provider provides mount tools that can mount a backup file to a local machine, such tools can be used to mount the backup file and represent the resulting mounted disk as a remote or local disk to the lab.
3. Where a 3rd party backup software provider provides mount tools that can mount a backup file to a local machine, doyenz can utilize methods described in universal agent disclosure to scan the mounted disk and translate/copy the blocks to an intermediate destination block level device that is compatible with destination lab
4. Where a third party backup software provider provides integration into a hypervisor, (e.g. storagecraft virtaulboot), doyenz can utilize a version of doyenz lab that is compatible with said 3rd party provider's choice of hypervisor and therefore make lab compatible with the source.
5. Otherwise any form of interception, integration, or instrumentation, or similar may be used to capture the needed data and configuration

Where any transformation is performed on the stored disks, such that the target lab's hardware differs from hardware abstraction layer deployed in the guest operating system on the source machine, and the operating system does not support universal hardware (e.g. windows) a special process of adjusting said source to be run in a lab with different hardware or hypervisor is performed.

In those steps, the source disks in the target format are mounted either locally in storage or in destination virtual machine or in special virtual machine where a specially designed piece of software replaces hardware abstraction layer and installs drivers to make the machine compatible with target lab.

Where 3rd party software used in restore process already provides such functionality it can be used as part of restore process by running the restore itself on the target physical or virtual hardware to automatically convert restored disks to be compatible with target physical or virtual hardware.

Restore/recovery may be implemented for different types and formats of data or machine, including but not limited to, file level, disk, machine, running machine, virtual machine, recovery directly into a live running instance.

Universal Failback

The act of failback differs from the act of restore or failover in that Doyenz could provide a machine that is either stored in doyenz storage or is running in Doyenz lab in a target format and/or to a target destination of customer's choosing and doesn't necessarily require running the machine in Doyenz or any other lab.

In case where doyenz storage used for regular store of the machine source or used as a transient translated format for running machine in the lab is compatible with target format required by customer, the source or transient storage is then transfered to the customer or to 3rd party cloud w/o any transformation applied to the data.

Where target format is different from the format that the source is stored in the Doyenz storage, and Doyenz stores the data in block-based format, and destination

In addition, any mechanism or method that applies to a backup and restore may apply to failback.

Example transformations and usage depending on available formats.

| Doyenz format | Target format | Actions |
|---|---|---|
| same as target | same as source | Download |
| 3rd party | 3rd Party | Mount and perform |
| mountable | | backup |
| 3rd party | 3rd Party | Mount both and perform |
| mountable | mountable | block-level copy |
| 3rd party | 3rd Party | Restore to a mounted |
| non-mountable | mountable | 3rd party target |
| 3rd party | 3rd Party | Restore to Doyenz block- |
| non-mountable | non-mountable | level storage and backup |
| | | from Doyenz storage using |
| | | 3rd party's backup software |
| Block level | Block-level | Transfrom header or |
| | with different | metadata and download |
| | header or other | |
| | metadata | |
| 3rd party | Block level | Mount and perform |
| mountable | any | block-level copy |
| 3rd party | Block level | Restore to a mounted |
| non-mountable | any | block-level |
| Block level | Different | perform block-level |
| | block-level or | copy |
| | mountable 3rd | |
| | party | |
| Block level | Non-mountable | Mount and backup from Doyenz |
| | 3rd party | storage using 3rd party's |
| | | backup software |

When the destination is a block-level format (or 3rd party cloud) and as such where 3rd party software is not required to perform transformation (if any), the actual target data is not necessarily stored in Doyenz cloud but could be stream directly

as downloadable stream to customer destination

or pushed as an upload stream to 3rd party cloud,

or downloaded by Doyenz Agent as any block-level format, where the agent assumes responsibility to provision set data either to locally available physical disks or directly to the customer's hypervisor of choice

Autoverified Backups

Doyenz may apply multiple levels of verification to make sure that at any given point in time backups and or imports and or other types of uploads into doyenz or any other service that implements doyenz technology where such backups uploads or imports in any way represent a machine are recoverable back into a machine representation whether it is a physical machine or virtual machine or a backup of such or any other machine recovery type.

All verification steps are optional. All verification steps may be performed before, during, or after the relevant other steps of system's operations. All verification steps may be performed in their entirety or partially.

Upload verification, preferably:
a. Every upload may be broken down into blocks a.k.a chunks and each chunk may be assigned a cryptographic or other hash value and/or checksum or fingerprint value.
b. A running checksum for the entire file/stream/disk being uploaded can also be calculated
c. The server can validate that the hash/checksum values for uploaded data can be independently recalculated and compared to the data calculated on the customer side to ensure that no discrepancy occurs during transmit.
d. In case of discrepancy the agent may retransmit the chunks where crc or checksum or fingerprint or hash values are in a mismatch
e. Before applying incremental changes, doyenz service responsible for copying uploaded bits may roll back to a previously known good snapshot, thus ensuring that any accidental writes or changes to the filesystem can be removed prior to apply.
f. Upon apply a new filesystem snapshot can be taken, thus ensuring that, preferably
   i. The data is safely committed to disk
   ii. The data cannot be tampered with (or the state before tampering is recoverable) once on disk and next apply has a reliable base to apply to or such base can be reconstructed.

Recovery verification, preferably:
g. Doyenz may employ a verification stage to verify recovery of every upload or of selected uploads (or backups or imports)
h. The verification stage is part of Doyenz pluggable architecture and backup providers (whether Doyenz or ThirdParty) can add verification steps
i. By default, generic verification step includes attaching the uploaded disk to a virtual machine, and/or verifying that it successfuly boots up and/or verifying that the os is initialized. In case of need, hardware independent adjustments are performed on the OS to ensure its ability to boot (e.g. replacement of HAL and installation of drivers).
j. Any adjustments or changes to the disk as the result of the boot can be discarded upon completion of verification using a temporary snapshot of the target filesystem (or other COW (here and elsewhere: copy on write) or similar mechanisms, or otherwise by creating a copy prior to verification)
k. In case verification fails, the backup can be chosen to not be allowed to complete, or other remediation steps can be taken to ensure validity of backups and if necessary can include notification of customers or of staff etc. . . .
l. In case a disk is not a block device, but the backup provider provides a means by which the backup files can be mounted as block device, the plug in for the particular backup provider can be used to allow mounting and performing similar verification as a block based device
m. In case a disk is not a block device but the backup provider provides tools for chain verification, verification plugin can perform chain verification as its verification step
n. In case the backup provider provides other means of backup correctness verification, the plug in will utilize those in the same general flow of apply->verify->finish or wherever the verification plugin is called, or on demand through the interface or through public doyenz api to make sure that every backup (or any particular backup) is recoverable
o. In addition, if no other verification is sufficient or possible, Doyenz rCloud can perform an actual B2C or V2C or any other type of conversion of the backup files in question to mountable disk format to ensure successful recovery and upon completion of B2C process can perform a virtual machine verification.
p. In addition, Doyenz plug in architecture allows Doyenz and 3rd party providers, including customers themselves to provide verification scripts. E.g. if customer has a line of business application and can provide a script that will ensure that line of business app is running upon system boot, doyenz verification process will execute this script during verification stage to make sure that the LOB application is performing properly upon every backup
q. Additionally, by providing multi tier plug in architecture to the verification process, Doyenz allows for business to provide tiered pricing options for different levels of verification, starting from basic—e.g. CRC/Hash upload verification and all the way to LOB specific verification scripts.
r. In addition, LOB specific verifications can be produced by Doyenz for popular applications, e.g. Exchange servers, SQL servers, CRM systems etc, to verify commonly used software is functional in the cloud version of the machine
s. In addition, those generic verification scripts for popular or otherwise chosen applications can be made customizable by customers, e.g. for exchange server, customer may provide a particular contact to be found, or a rule that a recent e-mail must exist etc. . . .

Fingerprint Map Reduction for Dedup

One of the ways to provide for uploads of large amounts of data is to represent each block or chunk of data being transferred with a unique hash or fingerprint or checksum value where such value is algorithmically calculated from the source data or otherwise identifies with some certainty the source value and compare those fingerprint/hash/crc etc values with a known list of previously transmitted or otherwise already existing values on the server side. However, to provide a hash value that one can be confident enough is truly unique; the hash values need to be significantly large.

It is usually accepted (though not required for the purpose of current invention) that such values should be in the order of 128 to 512 bits, or 16 to 64 bytes.

In addition, the likelihood of a block (or any other piece of data) being found to already exist, thus making deduplication efficient is in inverse proportion to the size of the blocks being hashed/compared. That is the larger the block, the more likely that every block in the transmit has experienced some level of change and will therefore have to be transmitted. On the other side, reducing the size of the block can lead to an unfavorable relation between the size of the hashed values compared to block sizes. For example, if one were to choose blocks of 512 bytes for best deduplication and 512 bytes hash size for best confidence and lack of collisions, the size of the hash is equal to size of original data, and therefore there is no advantage in using it at all.

Therefore, we propose a method of optimistic hash size reduction for the purpose of deduplication of data uploads.

In this scheme, the size of hash algorithm chosen can be (though not required to be) optimistically small, e.g. a standard CRC of 32 bit. This provides the benefit of fast calculation of hash and small sizes of hash values, also providing for fast exchange of CRC maps between the server and the client.

While this can lead to an increased rate of collisions, if the CRC or the hash differ, we can be guaranteed that the blocks are indeed different.

Given that they differ with mathematical certainty, we can transfer those blocks to the server w/o incurring the cost of storing and calculating larger hash values.

The rest of the blocks have the potential to exist on the server, but can also be a collision that was otherwise undetected because of relatively small size of the hash.

Next step of the process can now collect ranges of data comprising of multiple blocks that are suspect to be the same and perform validation of their equivalence either by utilizing tree hash algorithm (see description of tree based hashing dedup) or by calculating a single large size hash for every range. Those ranges of blocks that prove to be equal even after a significantly large hash comparison need not be transmited, while blocks that have proven to contain at least some collision using large block comparison need to be further examined.

Depending on the size of the remaining ranges, one can iterate through the process by using either next level in the tree using tree based dedup or by increasing the hash size one more step and repeating the entire process for each suspect range.

This provides for minimal data to be calculated and exchanged between the client and the server for the most efficient transfer of incremental changes in large files.

Tree Based Hashing for Optimal Change Transfer

When using hash (aka fingerprint or checksum) based fingerprint files to deduplicate transfer of large files, the fingerprint files themselves can be of significant size. E.g., using a 256 bit hash algorithm, on a deduplication block of e.g. 4 kbyte an example 2TB disk would produce a hash fingerprint of 16 GB. Exchanging that much information for the purpose of figuring out which blocks have changed can potentially be larger than the entire change to be transferred.

One solution to such problem is to hold a local cache of the fingerprint file. As long as this file is kept up to date and its validity can be verified (e.g. by exchanging a single hash for the entire fingerprint file) the local copy can be used as a true reference and blocks can be hashed and compared individually to the local fingerprint file.

If however local cache space is limited, the entire hash structure would need to be exchanged if each block is represented by a single hash. Assuming a limited hash size that can fit in memory, an alternative approach to identify changed blocks is a tree of hashes. A tree of hashes is a tree where each terminal node is a hash value of a particular block (e.g. 4 k size block), and each parent node is either a hash of the data of all its children or a hash of hashes of all its children. Hash of hashes differs from hash of all children by the fact that the source data used to calculate the hash of the larger block is the hash of the smaller blocks it is comprised of, whereas in the other case, the entire larger block source data is used to calculate the hash.

Taking for example available in memory (or on disk) buffer space of a little over 1 MB (and for example 4 kb blocks), one can read 256 blocks of data and fit it entirely into buffer. As they are read (or after they are read using a separate scan), a tree of hash values can bebuilt such that the lowest level of the tree contains hash values for each (e.g. 4 k) block, next level up containing hash values for e.g. each 8 k of blocks etc.

The overhead size of such hash tree would be (assuming binary tree, 256 bit hash 4 k block size) would be a total of 16 kb, where the root node of the tree would be a hash of the entire 1 MB.

This tree would correspond to a branch of a hash tree of the entire disk (or source data) that resides on the server. (e.g., in diagram below, the green subtree is for example a branch that corresponds to the first buffer, purple branch corresponds to next buffer read, where as all the nodes together comprise the hash tree of the entire transmission (or file/upload))

The branch location in the global tree is determined by buffer size (e.g. lmb) and offset in the disk (e.g. the purple branch is offset for example by lmb from the green branch in the diagram above), thus each client can use different buffer size depending on available memory and disk space and still utilize the same generic branch exchange algorithm.

The branch (or a tree of the buffer) will then be streamed to the server in BFS order. As the server starts reading the stream, first bytes represent the hash of the entire buffer. In case they are equal to the hash of the appropriate root of a branch in full tree representation, the server can immediately stop transmit with a response to the client stating that the branches are equal and next buffer can be filled. Such response can be done either synchronously (that is the client waits for a response after each hash or several hashes being transmitted, or after each bfs level, or any other number of hashes, or as an asynchronously read response stream, that is the server responds as the client uploads the hashes, w/o waiting for the entire transmission to end, and potentially as soon as the server has replies available after comparing with a local representation of the hash tree)

In case hashes at the root of the branch differ, the streaming continues, and the next two hash elements in the stream each represent a hash of half the buffer size (assuming binary tree) (the streaming does not necessarily need to wait for response, but can continue independently). Once again, the server continues to respond (either in line, or synchronously). E.g. if the first half differ and the other is equal, the server will respond instructing the client to continue traversal only on the first half of the branch. Server responses can be as short a single bit per each hash value. Continuing to go down, a bitmap of all blocks that actually differ will be negotiated, and the upload of actual data can begin (or be done in parallel as the blocks are identified).

Worst case scenario overhead for such algorithm, assuming the disk has completely changed is 2N where N is the size of a flat fingerprint file. However, for buffers that have not changed, the overhead is as low as a size of a single hash each. Assuming 5 percent change on each backup, the information that needs to be exchanged on a 2TB disk size to fully identify changed blocks, w/o requiring significant buffer space on the client side would amount to (assuming 256 bit hash, 4 k blocks) is a mere 1.6 GB, whereas the changed data size is 102 GB.

Plugin Based Cloud Architecture for Providers of Specific Decoupled Functions such as Restore, Hir, Automation, Etc.

In rCloud, some of the goals include the support of multiple representations of customer machines in the cloud, backing them up (or otherwise uploading/transmitting) into the cloud, verify such backups, run such machines in the lab, fail over to the cloud in case of disaster recovery and fail back to the customer environment when the event is over. In the real world of IT, customers have a diverse multitude of machine types and local backup providers that may be utilized in the course of their IT operation. Those include but are not limited to:

Physical machines with OS directly on the physical hardware

Virtual machines running in a variety of hypervisors

Local backups by multitude of third party backup providers with different backup strategies

Machines hosted in hosting environments

Virtual machines running in a third party cloud

Creating a regularly updated cloud based image of such machine sources is a conversion to the cloud. (X2C).

Doyenz therefore performs standardized operations on nonstandardized multiverse of sources.

By standardizing the operations, and then applying a plugin api to each or some of the operations, we can support the multiverse of sources by either minimal engineering investment in each new source of machine coming into the cloud, or allow third party providers to adjust their own solutions to be compatible with Doyenz.

Thus doyen can decouple—Source from Transport from Storage from Hypervisor from Lab Management etc. . . . and each can be independently adapted.

This allows us to change e.g. the best available hypervisor platform regardless of the type of VM customers chose to run etc.

Taking for example the process of daily backups

The preferably generalized process comprises one or more of the following—

If required, convert or transform the source where blocks of data can be accessed or received from the source

Identify changed blocks on geometry adjusted block disk representation of the source device

Upload changed blocks to Doyenz

Apply said changes to a snapshotted (or otherwise differential, e.g. journal) version of raw disk representation in the cloud

Verify that said machine contains a good backup.

In this case the identification and access to changed blocks may differ between each source of machine coming into the cloud, while the transport mechanism to the cloud may remain the same.

In addition, in the above example, each provider can require different type of verification, e.g. to verify that a StorageCraft backup is succesfull one needs to perform chain verification, or boot a VM etc.

More so, each customer can utilize the pluggable interface to provide specific verifications of their LOB applications or of (their) server functions. Such pluggable verification can give customers the guarantee that their appliances are in good operating condition in case of need for failover. That ability can also create a market for third party verification providers, or third party providers of HAL/driver adjustments for windows (a process required to boot a machine on a hypervisor that was not originally built on same hypervisor or is originally a physical machine).

The decoupled process of HAL/driver adjustments allows us to match any source to any hypervisor, thus allowing doyenz cloud itself be provided by a third party or on different hypervisor or physical platform, e.g. if doyenz wishes to run appliances on a foreign (non doyenz) cloud, the pluggable nature of doyenz architecture allows us to replace the plugin that adjusts windows machines to the target's cloud hypervisor and utilize it instead of local hypervisors.

Decoupling of storage and treating all/most sources as block devices allows Doyenz the flexibility of failing back to any target. That is a customer machine may start their life as physical machine, P2C to doyenz, then failover in the cloud and run in e.g. ESX virtualized environment that Doyenz cloud currently utilizes, and then fail back to customer environment as a Hyper-V appliance. (C2V)

Universal Prerestore

A restore of a source machine is a process by which such machine becomes runnable in the cloud or otherwise made executable and accessible by the user.

To run a machine in the cloud, when run on a hypervisor, the hypervisor (or physical machine if run on physical machines) must be able to access a disk in a format it can understand, e.g. raw block disk format, and the OS on this machine needs to have appropriate hardware abstraction layer and drives to be bootable.

Since Doyenz decouples the source format from the storage format and from the execution environment, the restore itself is the process of applying such HAL and driver translation and then attaching the disk to a hypervisor VM (or to physical machine) that can then execute it. Due to such decoupling, the restore itself is uniformly applicable regardless of the source that provides the storage format that is readable by the hypervisor (or other execution environment).

Supporting multiple sources universally for a purpose of restore is therefore in part a process of providing a common disk representation regardless of source.

This is obtained utilizing pluggable architecture. For most providers, at the client side, changes on the source machine or backup would be translated by the plug-in to a list of changed blocks, and those changed blocks would then be uploaded to rCloud to be applied to the common representation, thus making such sources restorable.

Alternatively, for sources that do not implement such plug-ins at the client side, a doyenz side plug in can provide a translation layer that will provide a mountable block device representation of a backup source or an api that the upload process can utilize to otherwise access blocks.

Such plug-in can utilize e.g. third party backup provider mount driver to present the chain of backup files as a standard block based device, or alternatively do a full scan read of such chain and write the results into a chosen doyenz representation of a block device mountable by hypervisors/execution environments. In addition, doyenz plug in can accept both pull and push modes, and can therefore represent itself as a destination for a third party restore or conversion, be that destination a virtualization platform or a disk format, whereas doyenz can read the data that is being pushed to it and transfer as blocks of data, with or without necessitating any changes in 3rd party software.

Individual File Restores on a Block Based Backup

Since doyenz utilizes decoupled storage, all backup sources are stored in a mountable block based device representation.

As long as the storage system has the appropriate file system drivers (NTFS for windows etc), the device can be mounted locally for individual file extraction.

A listing of files in the file system can either be pre-opbtained at the time of backup, or be retrieved on the cloud after the device was mounted.

A web based interface provides the listing of the files in a searchable or browsable format, where such listing is sourced either from a pre-obtained listing or online from the file system.

A user can chose a file or a directory he is interested in and the file is accessed from the mounted disk and provided in a downloadable format to the user.

Instant Availability of Backed Up Machines

Every machine in the cloud can be stored in a snapshotted chain of raw block devices, thus a restore can be a process of mounting such file system, adjusting it's hardware abstraction layer and then mounting it on a hypervisor/execution platform to become accessible.

Notably, none of the processes described above require time or processing that is necessarily related in any way to the size of the backup or source machine, and can therefore be done in constant or close to constant time, as opposed to a traditional full backup restore, the length of which is dependent on the size of the source machine or the backup files.

In addition, utilizing a cloneable COW file system, such mounting can be performed on a clone of a snapshot, thus allowing simultaneous restore from multiple restore points, simultaneous concurrent restores from the same restore point all the while continually providing new backups or other services (e.g. compaction) on the source snapshotted file systems w/o interfering with restores or requiring the restores to be queued in line past for other operations to complete

Instant Failover

A failover is a special kind of restore where machine is made to be available and running in the cloud and accessible by the customer.

Utilizing instant restore and availability, instant failover is made possible

Snapshot of the Applied Blocks Will Allow Point in Time Recovery Point

Usage of Snapshot/Clone/Copy on Write (COW) Based File Systems for Compaction/Retention Policy/Instant Spinoff of Multiple Instances for Block Based

Doyenz represents each individual volume on the source machine (or a volume on a source machine backed up by a local backup third party provider) as a single block device (or virtual disk format) accessible and mountable to a hypervisor.

Doyenz can utilize snapshot based file system, such that each backup is signified with a snapshot. When previous backup has a snapshot, we can overwrite blocks directly on the block device representation, w/o changing or modifying snapshots in any way since each change is using a COW and effectively creates a branch of the original during writes. Therefore, when a customer wants to restore, each and every saved restore point is individually available for mounting on the target hypervisor or the local OS (for e.g. file based restores).

To allow write modifications on the restored machine, Doyenz clones said FS snapshot instead of mounting it directly. Such clone operation performs another branch creation, so writes going to the block device representation can be seen in the target clone, but do not change the data on the original snapshot.

Thus an unlimited number of clones can be performed on an unlimited number of snapshots (restore points) all to be simultaneously restored.

Same mechanism allows for a deletion of individual restore points, thus compacting the space used by the chain without the need to do a full re-chain or rebasing of the backups. It is achieved by collapsing a snapshot that represents an older (or undesirable) restore point. Such operation on COW file system will cause the branched changes to be collapsed down to the previous snapshot. In case there is no difference, the change that no longer exists will not utilize any space. Since Doyenz can assign restore points to individual snapshots, a compaction is as simple as removing an individual file system snapshot on a COW file system.

Alternatives to Snapshot/COW Approach

Here and in every other parts where snapshot/COW file system is mentioned, other alternatives to achieve change tracking can also be used. For example, where snapshots are used to allow access to individual restore points, the same can be achieved by utilizing journaling mechanisms, or writing each difference in a separately named file etc.

While utilizing snapshot/COW file system may give an advantage of constant time execution on certain operation, it is not a necessary requirement for the invention, as long as each difference in restore point and in restored/executed machine representation can be individually accessed. Thus any mechanism allowing for branching of writes, including but not limited to version control systems, file systems, databases etc. can be utilized to achieve same goals.

Blocks Provider can be Generic

The Doyenz DR solution can be based on a defined generic programmatic interface which provides blocks to a consumer.

Different implementations of blocks providers can be implemented by different backup software vendors.

The blocks provider can provides a list of blocks which are the disk blocks that should be backed up and represent a point in time state of a disk

The list of blocks may be provided in the following forms:
t. Full disk backup blocks
u. Full disk used backup blocks
v. Incremental changes blocks from previous backup

A block in the provided list of block may contain the following information
w. Block offset on original disk
x. Block length
y. Block bytes (or enough context information to retrieve the bytes from a different location)
The blocks provider should be able to provide disk geometry information (cylinders, heads, sectors, sector size)

Block size may be dynamic
z. For optimized performance the block size provided may be different and change based on various characteristics

Doyenz may accept non-block, e.g., stream based, data, i.e., any data format that otherwise can be utilized by the rest of the system.

Blocks can be pushed to a different cloud storage provider (e.g., S3, EBS)

The storage of the blocks file can be at any cloud provider which supports storage of raw files or other formats supported by the system.

The backup agent can push the raw blocks to a storage cloud and notify Doyenz DR platform to pull the backup

Doyenz DR platform can pull the blocks files from that cloud storage and perform the x2C process.

Blocks Provider can be Developed by 3rd Party and Hook into Doyenz DR Platform.

Block providers can hook to Doyenz backup agent by using defined interfaces the agent provides

This particularly means that the base agent distributable binary does not have to contain the blocks providers for a certain backup solution.

The 3rd party backup product may allow the Doyenz agent to discover it and dynamically transfer the needed binary code for the blocks provider.

Some code authenticity check can be made to ensure code validity and safety and to prevent malwares from affecting the backup.

Blocks Provider May Push/Pull the Blocks Based on Schedule or Continuously

The programmatic interface used by blocks provider can be support both pull/push:
aa. Pull: the provider can returns blocks to the consumer when requested. It can be implemented in such a way that every call returns the next block.
bb. Push: the provider can send all of the blocks to the consumer when they are available.

For resume use case—the provider can start providing the blocks from different block offset

Conversion of Other Formats, Including Tape Based, to Block Based Backups

The provider can provide blocks which are not explicitly originated from a disk based format (for example 3RD PARTY BACKUP3rd Party Backup file format).

The provided blocks can appear as if they originated from a disk based format, e.g.: have block offset, length.

Converting Backups to Raw Disk Block Devices (Online and Offline)

Processing the blocks from the backup in preparation to DR VM usually means converting them to a certain Virtual Disk format (e.g. vmdk, vhd, ami . . . )

A more generic approach is to write the blocks to a raw blocks file format based on the blocks offset.

Different hypervisors can then mount the blocks file as a device if it is expose to them in a format they support (e.g.: iSCSI, NBD, . . . )

File Formats for Multi Block Sources

The backup solution can use a file format to describe all of the blocks that needed to be applied to target VM in the cloud

That file may refer blocks from multiple sources (e.g.: raw block file, previous backup disk etc.)

This can reduces the need to upload blocks which were previously uploaded to the cloud if there is a way to identify them.

Hypervisor Agnostic Cloud

The DR solution can recover backups of machines on any hypervisor by using standard interfaces to manage the VMs (e.g. Rackspace Could API)

This can be achieved for example by using the disk blocks devices mentioned above

Plugin Based Architecture (Agent)

The agent can be based on plugins which provide dynamic capabilities to different type of agents.

The plugins can define support for different blocks provider and other capabilities and behaviors of the agent

Universal Agent with Block Providers

Somewhat covered by previous items

The agent can be shipped with predefined set of blocks providers

The agent can be remotely upgraded to support additional blocks provider based on identified machines that needed to be backed up.

3rd part backup products can interface directly with the agent and push the blocks provider dynamically as needed.

Automatic Failback of Protected VMs (Reverse Backup, C2V)

Failback can be requested by user or otherwise initiated

Backend prepares a VM to be downloaded for failback

Agent can then downloads the VM and deploys to specified target

Agent may coordinates with backend to automatically provide deltas of the running DR VM to complete the failback on customer site.

Backend shuts down the DR VM when it has the right conditions have met (e.g. can determine that the time to transfer the next delta went under a certain threshold)

Agent can applies the deltas at customer at start the VM back on customer site

Files Block Based Backup

Block based backup concept should not be limited to full disk backups

It can be possible to implement block based backup for specific files/paths on a file system

Using file system driver the backup provider can trace write to certain files and save changed blocks information

Backup blocks provider for file based backups provides the blocks of the changed files

There could be additional mechanism tracks file meta data changes like ACLs, attributes etc.

Change Blocks Detection

Significance

Cloud DR solution may upload backups of incremental changes based on the customer recovery point schedule.

Since in many cases only a WAN link is available between the customer and the Cloud datacenter minimizing the uploaded size can significantly improve SLA (for example—meet a daily recovery point protected in the cloud).

In order to upload only incremental block changes a block change detection mechanism can be implemented.

Some of the approaches for detecting changed blocks are described below.

Using Backup Product Changed Blocks Tracking APIs

Some backup products provide APIs which can be used to retrieve a list of changed blocks from a certain point in time.

For example VMWare provides a set of APIs (vStorage API, CBT) for that purpose

Even when such specific APIs exists—limitations to their functionality may cause them to provide a super-set of all changed blocks (e.g.: vStorage API CBT might in some cases provide a list of all blocks on disk instead of just the blocks which were changed). Therefore in order to minimize upload size a dedup mechanism can be applied as well.

Comparing Mounted Recovery Point to Signature

In some cases the information of which blocks have changed on a disk is not directly available to Doyenz backup agent (e.g. StorageCraft ShadowProtect backup files, Acronis True Image backup files, backups which create VMWare vmdks etc). This is because the blocks information is stored in proprietary backup files with no programmatic which support accessing the changed blocks directly.

In many of those cases it may be possible to mount the recovery point file chain as raw blocks device (e.g. for StorageCraft ShadowProtect it is possible to use SBMount command, VMWare vmware-mount.exe can mount different vmdk types).

As mentioned above—if a signature file is created for a backup it can be possible to perform changed blocks detection by comparing all blocks on a mounted raw disk it is wished to be backed up.

Since this involve scanning of all disk sectors the process will be dependent on fast IO available to the scanning code.

An optimization for this could be scanning only sectors that contains used data. This could be obtained by accessing specific file system APIs and retrieve used blocks information (e.g. for NTFS it is possible to use $Bitmap file as a source for used blocks).

Tracing Writes to Virtual Disk

Some disk backup products have the capability of generation VM virtual disks (e.g. ShadowProtect's HeadStart)

This capability can be used by Doyenz agent to trace information about the blocks as they are written to the virtual disk by the backup product. Example of such information can be block offset, block length or even the blocks data.

Capturing blocks as they are written can be done in different way. Following are examples:
cc. Using file system filter driver which traces the write to certain destination
dd. Create a custom virtual file system and direct the Virtual Disk generation to it.

The virtual file system will proxy writes to the destination file while capturing the blocks information.
ee. Hook the backup product APIs used to write to the Virtual Disk and capture block information during the write.

In case block data (the actual bytes) were not captured—a secondary phase can be used to read the blocks from the Virtual Disk by mounting it using Virtual Disk mounting tools (for example VMWare VDDK).

Changed block detection in this case can be done for example by utilizing a previous backup signature file (compare digest of block against digest at signature file offset) or any other more sophisticated de-duplication technique mentioned in other documents.

Tracing Reads from Mounted Backup Files Chain

One of the challenges is determining the changed blocks in proprietary backup files chain (like for example a chain of backups from ShadowProtect, Acronis True image)

A possible approach could be to use a backup chain mounting tool to mount the chain as a raw disk device

The next step then can be to perform a scanning of the new device by reading each block on the disk

Using a file system filter driver to trace all reads from the file it may be possible to correlate between the blocks read from the disk to a backup files in the backup chain

Once the blocks for each file have been detected they can be used as blocks for a blocks provider

The agent can then upload only the blocks that are referenced by an incremental backup file

Emulating a Hypervisor Product

Some backup products have the capability of creating a VM by connecting to a Hypervisor3RD PARTY.

In order to perform changed blocks detection it may be possible to emulate the Hypervisor by creating a process which implements the protocol the Hypervisor uses. For example ESX emulation can implement the vSphere APIs and VDDK network calls in order to intercept the calls from the backup software.

The emulator can either simulate results to the caller or to proxy the calls to a real Hypervisor and proxy back the reply from the Hypervisor.

While the backup product performs writes to Virtual Disks—the emulator can capture the block information and written data in order to generate changed block detection.

The blocks can by de-dupped to avoid capture of pre-uploaded blocks to Doyenz datacenter.

Many of the different mentioned dedup techniques can be used in this case as well.

Other Methods

Other methods of obtaining change data, including but not limited to interception, integration, introspection, or instrumentation may be used.

All or some of the data may be obtained using any of the alternative methods.

Any number of the alternative methods may be combined and used together or alternatively.

Transmission Layer Deduplication

Transmission layer deduplication is an approach where there may be a sender and a receiver of a file, whereby the sender knows something about data that is already present on the receiver, and as a result, may only need to send:

Data that represents something unknown to the receiver

Data location information such that the receiver knows where to place blocks of data (either received from the sender, or retrieved locally) in order to reconstitute the target file.

The idea is that the file (or files) may be either lazily or eagerly reconstituted at some point in time after the transmission is complete. In the case of eager reconstitution, the file may be reconstituted prior to saving and reading (although it may be reconstituted into a reduplicated storage). In the case of lazy reconstitution, only the new block and location information data may be saved, and the file may be dynamically reconstituted from the original sources as the file is read.

Block Level Deduplication and Block Alignment

Deduplication may be performed on the basis of blocks within the file. In this approach, a fingerprint may be computed for each block, and this fingerprint may be compared to the fingerprints of every other block in the file, and to fingerprints of every file in the reference set of files. With a naive and rigid fixed size block approach, it is possible to miss exact matches because the reference block may be aligned against a different block boundary. Although choosing a smaller block size may remedy this in some cases, another approach is to use semantic knowledge of how blocks are laid out in the files to adjust block alignment as necessary. For example, if the target and reference files represent disk images, and the block size is based on file system clusters, the alignment should be adjusted to start at each of the disk image's file system's cluster pools. This may cause smaller blocks just prior to a change in alignment.

File Change Representation is Calculated Before Uploading and Verified when Applied

A file's signature itself does not need to be transferred as part of the upload. Since the sender knows something about the files on the receiver (through the signature), it can build a change representation that only:

Contains new data

References existing data on existing files

This representation can be computed and transferred on the fly. This means that the representation may not be known before the transfer begins.

The integrity of the representation can be verified by:

sprinkling checksums within the representation

appending the representation with an information block that contains:
ff. A magic number
gg. The size of the representation
hh. The checksum of the representation

or other means.

On apply, (assuming the starting file is a clone of the previous version of the same file) the representation may instruct the receiver to do a combination of one or more of the following steps

Leave a block in place

Replace a block with an existing block from a different file

Replace a block with an existing block from the same file

Replace a block with another from the representation itself

Signature Calculation

File Signatures may be calculated in many different fashions. For example, signatures can be computed for blocks in flight, or they may be computed on blocks laying static on a disk. Also, they may be represented in many different fashions. For example, they may be represented as a flat file, a database table, or in optimized hybrid data structures.

Canonical Compacted Signature Computation

A compacted signature includes a fingerprint and an offset for each non-zero block in the file being fingerprinted. In this case, the block size can be omitted because it is implicit.

One possible approach to computing a compacted signature is to start from the beginning of the file, and, using whatever semantic knowledge that is available, align with logical blocks in the file. For each logical block, compute the fingerprint. If the fingerprint matches the fingerprint of a zero block, do nothing. If it matches the fingerprint of a non-zero block, write out the start of block offset, and the given fingerprint.

Dynamic Fingerprinting

Fingerprints can be computed for individual blocks, or for runs of blocks. A fingerprint for a run of blocks is the fingerprint of the fingerprints of the blocks. This can be used to identify common runs between two files that are larger than the designated block.

An example of this approach:

When a match found, store the fingerprint, and track the offset and size

If the next block constitutes a match, check to see if it matches the next block in the previous version. If so increment the size and incorporate the next block's fingerprint into the larger fingerprint

Continue until a next block in the current file no longer matches a next block in the previous file.

Concurrent Signature Calculation on Sender and Receiver Sides

Both the sender and the receiver can have a representation of the final target file (such as a bootable disk image) on the completion of a transfer. In the case of the receiver, the representation can be the file itself. In the case of the sender, the representation can be the signature of the previous file, together with the changes made to the signature with the uploaded data. With this data, an identical signature of the final file can be computed on both sides, without having to transfer any additional data. On the sender's side, the signature can be computed by starting with the original signature, and modifying it with the fingerprints of the uploaded blocks. In the case of the receiver, the signature can be computed the same way, but it can also be periodically computed by the canonical algorithm of walking the file. In any case, it is valuable to have a compact method for determining that the signatures on both sides are identical. This can be done by computing strong hash (such as MD5 or SHA) on segments of both signatures, and comparing them.

Generational Signatures for Reliable Sender Side Signature Recovery

During an upload, a sender may deal with two signatures for each file:

The signature of the previous version of the file

The signature of the new version of the file

The sender may use the signature of the previous version to identify matches that do not need to be uploaded, and generate the signature of the current version to assist in the next upload. On completion of an upload, the receiver may need to verify the integrity of the uploaded data. Once it is verified, the sender can delete the signature of the previous version and replace it with the signature of the current version. If anything goes wrong with verification, the sender may need to use the signature of the previous version to re-upload data.

The sender may verify a file's signature before using it (by comparing strong hashes as described above). If the signature is incorrect, it can be supplied by the receiver, either in part, or in its entirety. In some cases, the on the receiver side may be reorganized (for example, by changing the finger print approach, or fingerprint granularity), which would invalidate all existing signatures. In any such cases, a correct signature can be re-computed on the receiver via the canonical approach.

Generational Signatures for Reliable Agent Side Signature Recovery

The agent may store a local copy of fingerprint file which it scans to determine which blocks require to be uploaded. However, when uploading blocks, the client may need to updated said file. In case of transmission error or a full upload failure, the client may then need to recover itself back to a state that is comparable to that of the server. This will be achieved by one of two approaches:
1. The updated hashes that may be transferred to the server may be kept in a local (client side) journal and only applied to the main file once a validation of successful upload has been received from the server
2. A new full fingerprint file may be created for each or some uploads. Old file may be deleted upon receiving a confirmation from the server that the upload is successful and current full hash on the server matches that on the client. (Generational)

Efficient Signature Lookup

In most cases, uploads may be for small changes to very large files. Since the files may be very large, their signatures may be too large to be read into physical memory in their entirety. In order to balance memory usage, a single strategy my work, but a hybrid approach may be also used for fingerprint lookup. For example, an approach might involve a combination of:

Caching the signature of a zero block

Caching the signature of commonly referenced blocks

Optimistic signature prefetching

Tree based random lookup

Optimistic Signature Prefetching

In most cases, the next version of the file being uploaded will share much of the same layout as the previous version. This means that in the common case, the signature of the current may be very similar to the signature of the previous version. To leverage this, the representation builder may fetch signatures for comparison (from the signature of the previous version of the file), from the portion representing the fingerprints of blocks slightly before the current checked offset, through blocks that fall a small delta beyond this. The representation builder can maintain a moving window, and fetch chunks of fingerprints as needed front he previous version In most cases, a fingerprint should match either a zero fingerprint, or a fingerprint in this prefetch cache. When there is no match, the new blocks fingerprint can be, or may need to be, checked against some or all fingerprints for the previous version.

Tree Based Random Lookup

In cases where a random fingerprint lookup is required, the representation builder can use a tree based approach. An example of this:

The signature file is sorted

Duplicate fingerprints are eliminated

An in memory datastructure is built that contains the first n bytes of a signature, and the offset in the file where fingerprints with this prefix begin.

Lookup then amounts to:

Do a hash lookup on the first n bytes of the target fingerprint against the above data structure (if there is no match, then the signature doesn't match any in the previous version)

Load the segment of the file that represents fingerprints with this prefix into memory

Do a lookup against the loaded segment.

Secure Multihost Deduped Storage/Transport

Blocks may be encrypted as they are written to storage. An index may be maintained to map the fingerprint of an unencrypted logical block to its encrypted block on a file system. Blocks can be distributed among storage facilities at various levels of granularity

Block by block

Logical files remain in place on a single storage host

Logical groups of files remain in place on a single storage host.

Unlimited Scalability

Storage in such a fashion can be scaled without limit. With a block level granularity, each new block can be written to a storage host with the most available space. With less granularity (i.e., files) data sets can be migrated to different storage hosts.

Pre-Balancing Larger Grained Distribution

In the case of larger grained distribution (e.g. file based) the load balancer may not know how large the unit will end up in advance. Series of uploads can grow a distribution unit well beyond its initial size. This means that a pre-balancing storage allocator for this level of granularity may make predictions about how large each unit will grow before allocating storage to it.

migrations

In some cases, larger grained distribution units may grow to be too large for their allocated host. In this case, they may be migrated to a different host, and metadata referring to them may be updated.

Service/Application Level/Grain Restore on Block Based Backup

To restore a service based on a block based backup the following steps may be used

Apply the backup to a disk image

Mount the disk image and collect the files and meta-data representing data for the given service

Perform any necessary transformations to the files to make them compatible with a target service (e.g., different versions of the same service, or different services performing similar functionality)

Instantiate the new service with the previously collected files and meta-data

Block Based Backup Using Command Line Tools

Blocks for a backup may be obtained using command line tools such as dd, which can be used to read segments of raw disk images as files. One approach to this would be to have the backup sender either resident on the system, or remotely logged in to the system that has the target files (for example, the supervisor of a virtualization host, such as ESX). The command line tool would then be run to read blocks to the sender. This could be optimized through a multi-phase approach such that the command line tool is actually a script that invokes a checksum tool on each block, and makes decisions on whether to transfer blocks based on whether the sender might need them. For example, the script could have some minimal awareness of the signature used by the client (e.g., fingerprints for zero blocks, and a few common blocks).

An advantage of this approach is that it can be used in environments where the system that has direct access to the files to be transferred does not have the resources to run a full sender.

An alternative includes naive implementation of a signature file. I.e.: flat file of digest per block offset (including empty blocks). The file size is the (disk size/block size)* digest size.

Blocked Based Architecture

The goal is to build a generic architecture which can enable cloud recovery in a generic way independent of the backup provider.

A backup provider provides blocks to backup per backed up disk (ideally only changed blocks)

Blocks source dedups the blocks and upload them to the cloud

Upload service stores the blocks on LBS in a generic file format

Store Service applies the blocks to a vmdk when backup is complete

VMDK can be booted in an ESX hypervisor

Future strategy could even abstract the persistent file format and store everything as raw disk bytes and then it will become hypervisor neutral.

Goal

Define file formats to be used for block based backups, transfer and apply. The files will be effectively used to ensure minimum number of blocks will be uploaded by using signatures and other dedup techniques.

Note: current focus is not deduping since this may be required only for 3RD PARTY Windows backup altough the proposed design addresses this but does not give full details for implementation.3RD PARTY.

Approach for Block Based File Format

This format may include one or more of the following:

Have a reference file

Have multiple sources of blocks

Describe only the blocks that are different (or in different positions) than they are in the reference file

Describe, for each block in the target file that is different, where to find the block in one of the block sources.

Include internal validation (i.e., if a file becomes corrupted, there should be a check that finds this without requiring any external data)

Ensure integrity of the source files

Incrementally transferred while reading from sources (no need to buffer it before uploading)

Support version to allow file format changes and extensions

Should be compact (significantly smaller than uploaded blocks)

Support upload resuming in case of interruption

Files Usage Scenario

We need to be able to handle the following example cases:

current—the file being backed up from the client and is written to the primary storage (usually vmdk)

case 1: // block is same as previous at the same offset
current |------------!a!-----------------|
previous |------------!a!-----------------|
case 2: // block was seen at a different offset in previous
current |----!a!-------------------------|
previous |----!b!-----!a!-----------------|
case 3: // block wasn't seen at all in previous
current |----!c!-------------------------|
previous |----!b!-----!a!-----------------|

previous—the previous version of the file backed up and snapshotted on the primary storage

Example pseudo code for usage on client agent side

prep:
// is the current signature valid?
if (no local signature or signature.hash != backend.signature.hash)
get fresh signature from backend;
for (block : blocksFromProvider)
{
handle(block);
}
handle(block)
{
h = md5(block.data);
if (signature.getHashAt(block.offset) == h)
{
// nothing to do - block is the same as previous one
(update stats and progress only)
}
else
{
// check if we have seen this block earlier
prev = blocksIndex.get(h);
if (prev != null)
{
assert (prev.offset != block.offset); // if false then blockIndex is out of sync
// we have seen this block in a different offset
write block meta to BU_token.blkinfo;
signature.update (block.offset, h);
}
else // this is a new unseen block
{
write block meta to BU_token.blkinfo;
signature.update (block.offset, h);
blocksIndex.update (h, block.offset);
write raw block bytes to upload stream file (BU_token.blkraw);
}
}
}

### Upload BU_token.blkinfo

### Design

### Terms Definition

Reference file—a file which represents the currently backed up disk device in the cloud (e.g. “/NE_token/diskl.vmdk”)

Blocks Source file—a file which contains blocks used as source of block information in the blocks file (e.g. the previous vmdk, “/NE_token/diskl.vmdk@BU_token”)

High level

The solution may use several files:

Raw Blocks File
ii. Contains consecutive raw blocks that needed to be applied to the current backup.
jj. The file can be generated and uploaded directly without being persisted to the local customer storage.
kk. For manual import the file can be generated into the import local drive

Block Changes Info File
ll. meta information about each block uploaded in the Raw blocks file
mm. Will be used by the backend to apply uploaded blocks to the correct target location.

Blocks Signature File
nn. A file which contains a checksum (md5) for each 4K block offset on the disk
oo. Used to check existence of a block before uploading it to reduce upload size in the common case

Blocks Hash Index File (Aka “Transport Dedup”, “Rsync with Moving Blocks”, “d-Sync”, “Known Blocks”)
pp. In order to determine if block bytes needed to be uploaded a fast index of block hashes is required.
qq. The index may be big and not fit in customer memory and therefore needs to backed by a disk file.
rr. The index will be cached locally at the customer and can be recreated from the signature file if needed.

Example Raw Blocks File Format

File name suffix

blkraw

Binary format

The file is a binary file

Byte ordering—Network Byte Ordering (Big-Endian)

File structure

Simple raw blocks laid out consecutively in the file.

|- - block0- -|- -block1- -|- -block2- -| . . . |- -blockN- -|

4 KB 4 KB 4 KB 4 KB

Example Block Changes Info Format

File name suffix

blkinfo

Binary format

The file is a binary file

Byte ordering—Network Byte Ordering (Big-Endian)

File structure

General Layout

| | |
|---|---|
| [symbol] | \|--header--\|--src file/s info--\|-------------changed blocks info------------------\| |

Header

| Length:16B | |
|---|---|
| [symbol] | \|--magic--\|--version--\| |
| [symbol] | |
| | int64 int64 |
| [symbol] | |
| [symbol] | |
| [symbol] | magic: 0xd04e2b10cdeed009 |
| [symbol] | |
| | version: 0x0001 |
| [symbol] | |

Source Files Information

Length:4B + N*1KB

| | |
|---|---|
| [symbol] | \|--files count--\|--file1--------\|--file2--------\|....\|--fileN--------\| |

[symbol]

| | |
|---|---|
| [symbol] | |
| | int32 1KB 1KB 1KB |

[symbol]

Source File Info Block

| Length:1KB | |
|---|---|
| [symbol] | \|--file md5--\|--file ID--\|--file name---------------------\| |
| [symbol] | |
| | 16B int32 1004B |
| [symbol] | |

Block Information

Length:36B

| | |
|---|---|
| [symbol] | \|--src file ID--\|--offset src--\|--offset ref--\|--block md5--\| |

[symbol]

int32 int64 int64 16B

[symbol]

[symbol]

| | |
|---|---|
| [symbol] | src file ID: the ID of the file defined after the header |
| [symbol] | |
| | offset src: offset in bytes on the source file (usually the raw blocks file) |
| [symbol] | |
| | offset ref: offset in bytes on the reference (target) file. |
| [symbol] | |

Sizing

Assume:

cluster size of backed up disk: 4 KB
Hash: MD5 (128 bit/16B)
Block info size: 36B

Uploaded size per 1 GB

1 GB/4 KB->262144 blocks->
blockInfoSize * 262144=36B * 262144=9437184B=9 MB per GB

100 GB used space would max to 900 MB (max because dedup would reduce it)

Example Signature File Format

File name suffix

blksig

Binary format

The file is a binary file

Byte ordering—Network Byte Ordering (Big-Endian)

Format options:

Flat Signature File
ss. Just md5 at corresponding offset that can be directly accessed by calculating offset in the file
tt. Unused zero blocks will also contain the signature
uu. Pros: very simple to implement and maintain (create, read, write)
vv. Cons: file size is big (4 MB per 1 GB of volume size) since it must contain all empty blocks.

Sparse Signature File
ww. Like the flat file but empty blocks hashes are not stored
xx. Pros: the file takes small amount of disk space—only the used blocks hashes. (4 MB per 1 GB of used size)
yy. Cons: implementation complexity—downloading the file from backend may require sparse download.

Compact Signature File
zz. File is compressed by containing offset:md5 pairs where zero blocks are skipped
aaa. Pros: the file is very small and compresses well on consecutive equal data and zeros.
bbb. Cons: no way to write into the file of new block since it will affect the compaction, therefore during backup a new delta signature file must be created and post backup will have to collapse the original with the delta to be the new signature. This process will have to accurately repeated on the backend side.

Example Index File Format

The requirement is to be able to do fast lookup of block offset given an md5 hash.

Possible Data Structures

B+Tree or a just use a database which effectively creates a B/B+tree on a table index.

Disk based hash table—flat file with hash collission buckets at constant offsets which need to be resized when a bucket gets full. The file should be mmap-ed for better performance.

Issues

B-tree drawback is that is suffer from fragmentation for the type of data we intend to use.

A mitigation strategy for this is creating pages with small fill factor which should reduce fragmentation till pages start to get full.

The hash table suffers from the need to rehashing when buckets get full.

So essentially both solutions suffer from similar problem and the choice should most likely be based on ease of implementation.

Design

Create an empty index

Insert/lookup index during backup

If need rebuild parts of the index while waiting for chunk upload to complete or rebuild all if must.

On the post backup signature processing—while rebuilding the new signature from repopulate the index with big fill factor so it would be ready for next backup.

Notes

If index get corrupted/missing—it can be rebuilt from the signature file like in step 4.

An optimization would be seed an index at the backend with known blocks for target OS/apps and send to client before backup start. This might have potential to reduce initial # upload size by 10-20 GB per server.

We can consider thinking if there is a similar data structure or enhancement to the current 2 options which will allow partial rebuilding of the index instead of full rebuild every time it is needed.

Alternative Approach

Create a file with sorted blocks hashes (md5) from the signature file

Build a Trie on top of the sorted hashes file

Maintain an in-memory block index (hash table or such) for new blocks

During backup lookup block in in-mem storage and then in the Trie.

Post backup processing will have to rebuild the sorter blocks hashes files by doing a merge from original file and the in-mem structure.

Design and Implementation Notes
ccc. the block info may be combined with raw bytes upload for simplicity (it was debated if that really is simpler or not)
ddd. Alternatives to MD5 as the fingerprinting algorithm can be used. SHA-X may be better for performance reasons (although the hashing is the least of the problem from time consumption perspective, JO is much bigger).
eee. support for different blocks sizes from the same block provider is an option
fff. For recoverability—generational signature files may be used. This may be needed in case backup gets aborted before completion—without it the sig file may become out of sync.
ggg. The support for multiple files may be an optional optimization initially.

Default single block source and since default target (e.g.: previous vmdk and single raw blocks source) may be used as an option.
hhh. “capabilities APIs” may be used where the blocks provider will have to match to certain backup capabilities (sending different block sizes, non-block aligned offsets, etc)
iii. The terms reference file, source file may alternatively be replaced by
   i. reference file->destination file
   ii. source file->server blocks file

BlocksTool

example utility

Blocks tool is a tool that used to test block based operations that are performed by the block based framework.

As new functionality is created and added to block based backup the new code could be tested using this tool.

Usage

```
  $ java -jar Blocks Tool.jar
  Usage: java -jar BlocksTool.jar <action> <options>
  --backup -cbt <cbt_xml_file> -srcvmdk <vmdk_file>
  [-sig signature_file] [-path
files_path]
  --apply -srcraw <source_blkraw_file> -srcinfo
  <source_blkinfo_file> -target
<target_vmdk>
```

backup input file:

cbt_xml_file: CBT info file in the format created by 3RD PARTYagent

vmdk_file: flat ESX vmdk file used as source for point in time backup

backup output files:

blkraw: raw blocks to upload

blkinfo: blocks information (refers to the blkraw file

blksig: blocks signature file of backed up disk.

Example:

```
  blockstool.sh --backup chgtrkinfo-b-
  w2k8std_r2_x64_1.xml w2k8std_r2_x64-
flat.vmdk
```

Backup

Creates block based backup files from source flat ESX vmdk (not the one created by 3^{rd} party!) and a CBT information in XML format that 3RD PARTYagent generates. Additional signature file is created unless passed a specific signature file from previous backup.

Apply

Performs blocks based copy from the block based backup files of all blocks into a target destination flat ESX vmdk file.

Example Usage

```
  $ java -jar Blocks Tool.jar --backup -cbt
  F:\\tmp\\blocks\\full\\chgtrkinfo-b-
w2k8std_r2_x64-000001-28-11-2011-09-59.xml -srcvmdk F:\\tmp\\b
  locks\\full\\w2k8std_r2_x64-flat.vmdk -path f:\\tmp\\blocks
  Performing Backup:
  cbtXmlFile = F:\tmp\blocks\full\chgtrkinfo-b-w2k8std_r2_x64-000001-
  28-11-
2011-09-59.xmlsourceVmdkFile = F:\tmp\blocks\full\w2k8std_r2_x64-fl
  at.vmdk
  sigFile = f:\tmp\blocks\7c537730-3615-476d-aa96-03b6dcc1f3cb.blksig
  rawBlocksFile = f:\tmp\blocks\7c537730-3615-476d-aa96-
  03b6dcc1f3cb.blkraw
  blocksInfoFile = f:\tmp\blocks\7c537730-3615-476d-aa96-
  03b6dcc1f3cb.blkinfo
  ..
  $ java -jar BlocksTool.jar --apply -srcraw F:\\tmp\\blocks\\
  11ff07ad-87b6-4db6-
872f-b33ff01c48bb.blkraw -srcinfo F:\\tmp\\blocks\\11ff07ad-87b6-
4db6-872f-
b33ff01c48bb.blkinfo -target F:\\tmp\\blocks\\target_restored.vmdk
```

Example Generic Block Based Agent Class Design

| | |
|---|---|
| | Example implementation: |
| [symbol] | class BlockInfo |
| [symbol] | { |
| [symbol] | long offset, |
| [symbol] | long length; |
| | byte[ ] data; |
| [symbol] | |
| | } |
| [symbol] | |
| [symbol] | interface BlocksReader |
| [symbol] | { |
| [symbol] | BlockInfo readBlock (long offset, long length); |
| [symbol] | } |
| [symbol] | |
| | // reads blocks from a vmdk using vddk |
| [symbol] | |
| | class VddkBlocksReader implements BlocksReader |
| [symbol] | |
| [symbol] | // reads blocks from ESX cbt snapshot point |
| [symbol] | class VadpBlocksReader implements BlocksReader |
| [symbol] | |
| [symbol] | // reads blocks from raw mounted windows disk block device |
| [symbol] | class RawDeviceBlocksReader implements BlocksReader |
| [symbol] | |
| [symbol] | interface BlocksProvider implements Iterable<Blocklnfo> |
| [symbol] | { |
| | Iterator<BlockInfo>iterator( ); |
| [symbol] | |
| | } |
| [symbol] | |
| [symbol] | // opens vmdk from IMG*x backup path and uses change blocks |
| | xml from 3^{rd} party3RD PARTY |
| [symbol] | class 3rdPartyVmdkBlocksProvider implements BlocksProvider |
| [symbol] | { |
| | 3rdPartyVmdkBlocksProvider ( |
| [symbol] | String vmdk, |
| [symbol] | |
| | String changedBlocksXmlFile, |
| [symbol] | |
| | VddkBlocksReader reader) |
| [symbol] | ... |
| [symbol] | } |
| [symbol] | |
| [symbol] | // opens local vmdk generated by 3rd Party convert and reads blocks |
| [symbol] | class BeWinVmdkBlocksProvider implements BlocksProvider |
| [symbol] | { |
| | BeWinVmdkBlocksProvider ( |
| [symbol] | |
| | String vmdk, |
| [symbol] | byte[ ] writtenBlocksBitmap, // captured using vddk hooking |
| [symbol] | VddkBlocksReader reader) |
| [symbol] | ... |
| [symbol] | } |
| [symbol] | |
| | // uses VADP APIs to get the changed blocks from ESX vmdk |
| [symbol] | class VADPBlocksProvider implements BlocksProvider |
| [symbol] | { |
| [symbol] | IVADPBlocksProvider ( |
| [symbol] | ESXConnection con, |
| [symbol] | String vmdk, |
| [symbol] | BackupContext ctx // the snapshot sequence id etc. |
| [symbol] | ) |
| [symbol] | } |
| [symbol] | |
| | // mount v2i files chain and reads blocks from mount |
| [symbol] | class 3RDPARTYv2iBlocksProvider implements BlocksProvider |
| [symbol] | { |
| [symbol] | 3RDPARTYBlockProvider ( |
| [symbol] | String v2iFile, |
| | byte[ ] writtenBlocksBitmap, |
| [symbol] | |
| | RawDeviceBlocksReader reader) |
| [symbol] | |
| | ... |
| [symbol] | |
| | } |
| [symbol] | |
| [symbol] | // mount tib files chain and reads blocks from mount |
| [symbol] | class AcronisBlocksProvider implements BlocksProvider |
| [symbol] | { |
| | AcronisBlocksProvider ( |
| [symbol] | |
| | String tibFile, |
| [symbol] | byte[ ] writtenBlocksBitmap, |
| [symbol] | RawDeviceBlocksReader reader) |
| [symbol] | .. |
| [symbol] | } |
| [symbol] | |
| | // sbmount sp files chain and reads blocks from mount |
| [symbol] | |
| | class SPBlocksProvider implements BlocksProvider |
| [symbol] | { |
| [symbol] | SPBlocksProvider ( |
| [symbol] | String spFile |
| [symbol] | byte[ ] writtenBlocksBitmap, |
| [symbol] | RawDeviceBlocksReader reader) |
| [symbol] | ... |
| [symbol] | } |
| [symbol] | |
| | // mounts VSS snapshot and read blocks from mount |
| [symbol] | class VSSBlocksProvider implements BlocksProvider |
| [symbol] | { |
| [symbol] | VSSBlocksProvider ( |
| [symbol] | Guid shadowId, |
| [symbol] | byte[ ] writtenBlocksBitmap, // captured somehow, VSSProvider? |
| [symbol] | RawDeviceBlocksReader reader) |
| [symbol] | |
| | ... |
| [symbol] | } |
| [symbol] | |
| [symbol] | // mounts VHD and reads blocks from mount / use hv snapshots? |
| [symbol] | class HyperVBlocksProvider implements BlocksProvider |
| [symbol] | { |
| | HyperVBlocksProvider( |
| [symbol] | |
| | ? |
| [symbol] | ) |
| [symbol] | ... |
| [symbol] | } |

Example Usage3RD PARTY:

| | |
|---|---|
| [symbol] | BlocksProvider p = new 3rdPartyVmdkBlocksProvider ( |
| [symbol] | “e:\backups\IMG00002\disk1.vmdk”, |
| [symbol] | “cbt_file.xml”, |
| [symbol] | new VddkBlocksReader(“.\vddkBlocksTool.exe”, cmdExecutor), |
| [symbol] | ); |
| [symbol] | |
| [symbol] | Iterator<BlockInfo> it = p.iterator( ); |
| [symbol] | while (it.hasNext( )) |
| [symbol] | { |
| | BlockInfo b = it.next( ); |
| [symbol] | |
| | blocksHandler.handle (b); |
| [symbol] | |
| | } |

Manual Onboarding

Intake Device

As one of the steps of transferring machine sources from the customer and to the cloud, Doyenz have developed a method and built an apparatus that can be used to transfer customer (or any other) source machines on physical media.

In one example embodiment of the intake apparatus, the physical media is standard hard drives.

The Copy Agent

In this device, the doyenz agent can utilize it's plugin architecture to perform all standard steps of identifying machine configuration, getting source blocks or source files etc, but where a transfer plugin differs from a standard plug-in. This “manual intake” aka “drive intake” transfer plug in substitutes uploading of the data to the cloud with copying the data to a destination disk. The plug in can be a meta-plug in that has two functionalities combined—on one hand the copying of the data to a physical media, and on another hand a plug in used usually on the cloud side of the Doyenz cloud that can ensure that the data written to disk can be formatted and stored in the same way a doyenz upload service in the cloud would have stored it in the transient live backup storage (a transient storage that can be used to store uploads before they complete and ready for application to the main storage)

The agent further comprises
an integration service that upon request from the user can generate a shipping label using either user's or Doyenz shipping account with a standard shipping service, update the disk with the shipping number and unique id that would allow Doyenz to identify the disk with the shipping.
an integration service that integrates with Doyenz (or the business that operates doyenz based cloud) CRM and sales system thus tying in and referencing the support/crm/sales ticket with the process of manual onboarding and putting enough identification information on the shipped disk to make such integration identifiable by the intake apparatus

The act of copying the data to the disk, shipping it and then copying to the cloud is generally faster than a direct upload (depending on bandwidth and other factors.), however, it introduces a delay for the time that the disk is in the shipping and processing. The agent may be able to utilize such delay by starting an upload of next backups even before the original on disk backup was applied in Doyenz. This can be achieved by maintaining ordered list of backups and corresponding files and sources and being able to reorder the application of such uploads on the cloud side.

The Drive Intake Apparatus

On the cloud side, the drive intake apparatus may be comprised of a computer system with a hot-swappable drive bays attached to disc controllers. On said device, a special intake service is running. The service comprises of the following mechanisms:
2. A detection mechanism can beused to detect drives as they are inserted into the bays
3. A mechanism can beused to identify drives and the backups on them, and thus know whether the drive was already processed or not
4. A mechanism that can transition or trigger the rest of the system to think that the backup or upload are fully uploaded and are ready to be applied to the main storage
5. A mechanism that can forensically or simply wipe the disk and make it available for reuse upon completion of the “upload”.
6. A monitoring console that displays all existing drive bays and displays whether they contain valid uploads, whether those uploads are in the process of being applied to the main storage and whether the intake apparatus is done with a particular drive. A user of the console has indication whether the drive is ready to be taken back into circulation (or sent back to customer if originated from the customer) and which bays are available for use.
7. A database structure (or other configuration structure) that presents each bay as a standard doyen live backup system and therefore allows the rest of the system be decoupled and not require specific knowledge whether the source came from upload or was sent in a mail by a customer

Backup Software Integration

This entire section of the document is one possible implementation of the general system. The section refers to specific 3^{rd} party software as examples only. Other combinations of software and alternative implementations exist.

### Solution Proposals

Customer side Incremental VMDK based: Note: we have since learned that they pulled support for vmdk generation without a esx host
jjj. Snapshot Approach:
   i. Artificially set snapshot before writing incremental to VMDK (by altering text in VMDK file) so that writes go to a delta file instead of the flat file
   ii. Send the deltas to doyenz,
   iii. Fake a vmsd
   iv. Perform apply as with esx/vsphere backups
   v. Collapse snapshot at client side via one of many possible fragile approaches:
      1. Get change blocks from DC
      2. Mount vmdk twice—once with the delta and once without. Merge changes from the delta mounted one to the non-delta mounted one. Needs validation to ensure that the same flat file can be mounted from two different vmdks without causing problems.
kkk. File tracing approach
   i. Trace writes to the VMDK to identify the change blocks.

Dedup server based & Doyenz side incremental VMDK or traditional restore
lll. Synchronize a dedup server at customer site and at doyenz, and try to generate incremental vmdks from that server
mmm. Run 3^{rd} party+Dedup server at Doyenz, none at customer site, and have customer site agents send directly to doyenz (using client side dedup)
nnn. Use client side dedup, client side 3^{rd} Party (for local backups) and set Doyenz up as an OST dedup server, try to generate incremental VMDKs from that.
ooo. Syncronize 3rd Party/Dedup at customer site with a Doyenz build 3rd Party dedup solution receptical (to make it multi-tenanted and reduce the memory requirements—it doesn't need to dedupe amongst clients) and feed this data to a 3^{rd} party server to do VMDK based restores.

3RD PARTY 3^{rd} Party Approach Investigation and Progress

Basic Technical Requirements

Online seeding

Backup Upload

Manual seeding

Storage/Storage management

Trial restores

Failover

Failback.

Complications in Backing Up from 3rd Party

Backups are all written in tape format, to actual tape, or to 3RD PARTY BACKUP if the data is written to disk

The tapes represent files, not disk images

Incremental 3RD PARTY BACKUPs are big because they contain the entire contents of any files that were changed.

Lack of 3^{rd} Party deletion tracking requires frequent rebasing

Customer upload bandwidth is not expected to be significantly better than the current approach

Solutions Diagram

Transport Options

Direct Upload of 3RD PARTY BACKUPs

We can build a custom agent that uploads 3RD PARTY BACKUP files. Implementation may involve detecting the 3rd Party Backup files that correspond to a specific backup, This could be handled through the powershell api. This may also require re-cataloging on or side.

Customer-side Implications Customer must have sufficient bandwidth to upload ˜200 GB/wk/server (assuming each server is approximately 120 GB).

Datacenter Implications Doyenz must provide sufficient bandwidth to upload all customer data on a regular basis.

Data Encryption Data can be stored encrypted

Restore Implications Does not provide instant restores. Requires 3^{rd} Party in the Doyenz datacenter to perform restores

Development cost* *Small in comparison to others

Supportability* *Uncertain. Biggest support risk involves the restore using 3rd Party.

Storage implications Similar to our current storage for shadow protect—without the snapshots per backup.

Storage management Requires rebasing and deleting a prior series of backup sets.

Machine management Machines would have to be co-managed by Doyenz and by 3rd Party. Doyenz would need to keep track of each one for backup purposes, and 3^{rd} party would need to track them for restore purposes.

Pros simplest solution, should be easy to create agent plugins to handle this.

Cons Large amount of data upload, requires a lot of bandwidth in order to meet our SLAs. Slow restores that have lots of moving parts

3^{rd} Party to 3RD PARTY STORAGE APPLIANCEs

Approach outline: Customer does not have 3RD PARTY STORAGE SOLUTION on site. Customer either schedules backups to go directly to a 3RD PARTY STORAGE APPLIANCE running in Doyenz's cloud, or schedules a set-copy following standard backups to transfer them to a 3RD PARTY STORAGE APPLIANCE running in Doyenz's cloud. The Doyenz side 3RD PARTY STORAGE APPLIANCE is started at the beginning of the backup or set-copy job, and closes down on the completion of the job. This requires re-cataloging on our side.

Customer-side Implications Customer must either give up local copies, or must add a set copy to their existing schedule.

Datacenter Implications Doyenz must provide a VM running 3RD PARTY STORAGE APPLIANCE, with ˜4 G of memory for each customer for the duration of upload. SSH tunneling will be required or a dedicated public IP per customer will be required

Data Encryption Setcopy will store unencrypted data locally.

Restore Implications Requires 3^{rd} Party in the Doyenz datacetenter to perform restores

Storage implications Servers backed up by a single instance of 3^{rd} Party are stored together in the VMDK corresponding to their instance of 3RD PARTY STORAGE APPLIANCE.

Storage Management Each 3RD PARTY STORAGE APPLIANCE instance is stored in ZFS in a similar fashion to our current machine storage. A snapshot is taking following each 3rd Party dedup solution, and snapshots are backed up via zfs sends to an archive.

Machine Management Machines are stored together for a customer, and are not separable without a 3RD PARTY STORAGE APPLIANCE instance.

Supportability and Operations cost Unknown. It may require 3rd Party help to sort out corrupted repositories. So far, there are lots of ways setting up a 3RD PARTY STORAGE APPLIANCE and getting 3rd Party Dedup Solution to work to it can fail.

Pro Uses a “proven” deduplication solution

Cons
ppp. Requires 3RD PARTY STORAGE APPLIANCE to backup and recover data
qqq. 3RD PARTY STORAGE APPLIANCE3RD PARTY STORAGE APPLIANCELots of moving parts, fragility
rrr. 3RD PARTY STORAGE APPLIANCE does not communicate internal problems

Risks
sss. 3RD PARTY STORAGE APPLIANCE's are touchy about configuration, and when misconfigured, they don't give clear indications about what needs to change.
ttt. We don't have a robust, mechanical, way of spinning up 3RD PARTY STORAGE APPLIANCEs that leads to simple instructions for automation
uuu. Lots of moving parts that are out of our hands
vvv. We don't know the traffic compression rate of this approach.
www. We don't know how robust the storage on 3RD PARTY STORAGE APPLIANCEs will be at this point

Solution Cost Development, operations and support costs are high

3Rd Party Storage Solution 3rd Party Dedup Solution

Approach outline: Customer installs 3RD PARTY STORAGE SOLUTION on their site, schedules an 3rd Party Dedup Solution job with each that synchronizes their repository with a 3RD PARTY STORAGE APPLIANCE running in Doyenz's cloud. The Doyenz side 3RD PARTY STORAGE APPLIANCE is started at the beginning of the 3rd Party Dedup Solution job, and closes down on the completion of the job. This requires re-cataloging on our side.

Customer-side Implications Customer must have 3RD PARTY STORAGE SOLUTION installed.

Datacenter Implications Doyenz must provide a VM running 3RD PARTY STORAGE APPLIANCE, with 2 to 4 G of memory for each customer for the duration of upload. 3rd Party storage solution to 3RD PARTY STORAGE APPLIANCE communication will require a VPN connection

Data Encryption Data is store and transmitted encrypted

Restore Implications Requires 3rd Party in the Doyenz datacetenter to perform restores

Supportability *and Operations *Unknown. It may require 3rd Party help to sort out corrupted repositories. So far, there are lots of ways setting up a 3RD PARTY STORAGE APPLIANCE and getting 3rd Party Dedup Solution to work to it can fail.

Storage implications Servers backed up by a single instance of 3rd Party are stored together in the VMDK corresponding to their instance of 3RD PARTY STORAGE APPLIANCE.

Storage Management Each 3RD PARTY STORAGE APPLIANCE instance is stored in ZFS in a similar fashion to our current machine storage. A snapshot is taking following each 3rd Party dedup solution, and snapshots are backed up via zfs sends to an archive.

Machine Management Machines are stored together for a customer, and are not separable without a 3RD PARTY STORAGE APPLIANCE instance.

Pros Uses a “proven” deduplication solution

Cons
xxx. Requires 3RD PARTY STORAGE APPLIANCE to backup and recover data
yyy. 3RD PARTY STORAGE APPLIANCE3RD PARTY STORAGE APPLIANCELots of moving parts, fragility
zzz. 3RD PARTY STORAGE APPLIANCE does not communicate internal problems

Risks
aaaa. 3RD PARTY STORAGE APPLIANCE's are touchy about configuration, and when misconfigured, they don't give clear indications about what needs to change.
bbbb. We don't have a robust, mechanical, way of spinning up 3RD PARTY STORAGE APPLIANCEs that leads to simple instructions for automation
cccc. Lots of moving parts that are out of our hands
dddd. We don't know the traffic compression rate of this approach.
eeee. We don't know how robust the storage on 3RD PARTY STORAGE APPLIANCEs will be at this point

Solution Cost Development Cost Development, operations and support costs are high

VSS Snapshots of Local 3RD PARTY STORAGE SOLUTION

Approach outline: Customer installs 3RD PARTY STORAGE SOLUTION and a Doyenz agent on their site. Customer schedules backups to run against the 3RD PARTY STORAGE SOLUTION, with a post command to notify the agent of completion. Following each backup, the Doyenz agent performs a VSS snapshot, and sends the file changes since the last backup to Doyenz. This requires re-cataloging on our side.

Customer side implications May require a custom VSS provider to capture changes in data.

OpenDedup Synchronization

Approach outline: Customer installs a Doyenz agent and sets 3rd Party up to do incremental VM generation (either to ESX or Hyper-V). The Doyenz agent sets up a file system on top of OpenDedup to receive the generated VMs, and uploads the deduped VM via OpenDedup's synchronization mechanism.

Storage implications Storage can becompletely managed by OpenDedup

Storage Management Storage management is mostly out of our hands.

Machine Management Potentially, manage machines as a root directory with each backup being a sub directory.

Customer-side Implications Customer should preferablyt be running a hypervisor that mounts an OpenDedup volume.

Datacenter Implications Doyenz should preferably establish and maintain one or more OpenDedup services.

Restore Implications If we are backing up vmdks, we get instant restore. OpenDedup provides an NFS service, which we just mount from the ESX host.

Supportability*. Although OpenDedup can beopen source

Pros
ffff. Gives us control of the dedup solution
gggg. Provides for the potential of instant restores.

Cons
hhhh. Immature and somewhat complex dedup platform.

Lightweight Dedup Transmission (Much Like Rsync with Block Motion)

Approach outline: Customer installs a Doyenz agent. The Doyenz datacenter and the customer agent share a dedup fingerprint for some number of previous uploads. Agent uses this to map blocks of next upload, uploads a new fingerprint and any require changes. Doyenz writes new blocks and rearranges existing blocks in storage to match the dedup fingerprint. The effect is that this dedups transmission, but not necessarily storage.

Use for VMDKs

The previous VMDK should be adequate for providing the fingerprint for the next upload.

Experimental results show that this works fairly well with 4 k blocks.

Better results may be obtained by utilizing VMDK structures for exact block alignment.

Use for 3RD PARTY BACKUPs

This approach requires a number of prior 3RD PARTY BACKUPs for fingerprint matching, and somewhat more complex data structures for keeping track of which file contains which block.

It also requires parsing of the 3RD PARTY BACKUPs to achieve any reasonable block alignment.

Need the 3RD PARTY BACKUPs to be stored unencrypted.

Need to go back to every and look at every incremental until a rebase.

Need a file system equivalent to track the authoritive source of specific blocks

Backup Capture Alternatives

Capture 3RD PARTY BACKUPs

Approach outline
iiii. Customer points a Doyenz agent at a storage facility for 3RD PARTY BACKUPs
jjjj. Agent performs some sort of chain analysis and uploads 3RD PARTY BACKUPs as necessesary.

Transmission implications Not really feasible without some sort of dedup.

ESX Host

Approach outline:
kkkk. Customer has an ESX host.
llll. 3rd Party is configured to perform incremental P2V restores to this host at each backup
mmmm. Doyenz captures the changed blocks and either uploads them as they are, or does a transmission level dedup/redup

Transmission Implications Not particularly feasible without block level dedup

Customer Implications Requires an ESX host

Restore Implications HIR is already completed. Can be handled in a similar fashion to ESX backups.

Hyper-V Host

Approach outline:
nnnn. Customer has an Hyper-V host.
oooo. 3rd Party is configured to perform incremental P2V restores to this host at each backup
pppp. Doyenz captures the changed blocks and either uploads them as they are, or does a transmission level dedup/redup

Transmission Implications Not particularly feasible without block level dedup

Customer Implications Requires Hyper-V (comes with SBS 2008 R2)

Restore implications Can be handled in a similar fashion to ESX backups. Requires HIR at restore time

ESX Stub

Approach outline:
qqqq. Doyenz agent will run a local web server which mocks vSphere API calls.
rrrr. Customer starts 3rd Party incremental convert to ESX VM which the ESX stub intercepts and return proper responses to 3rd Party.
   i. Intercepting vSphere API calls can be done using a web server
   ii. Intercepting vStorage API calls can be done by hooking VDDK library or implementing a TCP based mock server.
ssss. Write requests to the vmdk will be de-dupped and written locally.
tttt. Doyenz agent will upload the de-dupped VM and apply to a VM stored in the cloud.

Customer-side Implications: has to allow the local web server to run and bind to ESX ports and have enough memory and storage for efficient dedup.

Storage implications: re-dupped VM will take significant storage unless dedupped again in a dedup enabled file system.

Restore implications: restore is immediate and similar to current ESX/vSphere restore

Pros:
uuuu. Low customer requirements
vvvv. Instant restore

Cons:
wwww. Slightly invasive if we are replacing all ESX calls made to go through a stub
xxxx. Need to deal with fragility and complexity of the vSphere APIs
yyyy. Need to deal with cases where customer has web server which listens on the same port
zzzz. High cost in development and handling edge cases

Variation of this idea which could be used as a more expensive but incremental path towards this solution is to implement a reverse proxy to a real running ESX instance at Doyenz DC and de-dup only the writes transport calls.

Restore Alternatives

Run 3rd Party in the Doyenz Datacenter

Approach outline: 3rd Party starts, updates its catalog from the repository, and performs the following steps:

B2V restore of the system full, without applications

Simultaneous restore of applications, system incrementals, and application incrementals.

Customer Implications Restores might be very slow.

Datacenter Implications Either need to take a large additional hit for cataloging at restore time, or the data center needs to re-catalog frequently. If we re-catalog frequently, we need to manage a large number of 3rd Party instances (on the order of 1 for every 25 to 100 customers uploading VMs).

Receive VMs from Customer

Approach outline: Data uploaded corresponds to hard drive blocks and possibly VM meditate files. These are applied to a VMDK on the Doyenz side following receipt. Restore is a matter of starting up the given VM on an ESX host in the datacenter.

Customer Implications The customer may need to do some additional configuration to set up the VM generation on their side. Restores seem nearly instantaneous.

Datacenter Implications Depending on how they are generated, we may need to run HIR on VMs at restore time.

Storage alternatives

Storage inside of a dedup repository

Storage as VMs in ZFS snapshots

Storage as raw 3RD PARTY BACKUPs

Failback alternatives

Send VM back to customer

Update a dedup repository and synchronize this back to the customer

Perform a full 3RD PARTY BACKUP backup and send 3RD PARTY BACKUPs back to customer

Full Solution Proposals

3RD PARTY STORAGE SOLUTION to 3RD PARTY STORAGE APPLIANCE

3rd Party to 3RD PARTY STORAGE APPLIANCE Approach

Basic Approach

Customer does not have 3RD PARTY STORAGE SOLUTION on site. Customer either schedules backups to go directly to a 3RD PARTY STORAGE APPLIANCE running in Doyenz's cloud, or schedules a set-copy following standard backups to transfer them to a 3RD PARTY STORAGE APPLIANCE running in Doyenz's cloud. The Doyenz side 3RD PARTY STORAGE APPLIANCE is started at the beginning of the backup or set-copy job, and closes down on the completion of the job.

Backup Path

From the customer perspective:

Customer installs the Doyenz agent.

Customer adds a Doyenz based 3RD PARTY STORAGE APPLIANCE as an OST target. This is done through either a customer specific public IP, or through tunneling from a local interface to Doyenz.

Customer either makes this the target of the backup for a Doyenz managed machine, or, if the customer wants a local copy of the backup data, the customer makes this the target of a set-copy following the backup.

If the backup to Doyenz, or set-copy to Doyenz fails, 3rd Party will try again on the next scheduled backup.

The customer will have a web interface, provided by Doyenz, to which he or she can connect, and view backups that have been stored. The customer can use this interface to perform test restores and fail-overs.

Technical implications:

Doyenz will need to set up a 3RD PARTY STORAGE APPLIANCE for each customer
aaaaa. Need to determine how many of these can run simultaneously on an ESX host
bbbbb. Stored as VMs on a store service

Customer will need to install Doyenz agent, which may configure tunneling in order to connect to a cloud based 3RD PARTY STORAGE APPLIANCE

Doyenz will need to make 3RD PARTY STORAGE APPLIANCE available for initial connection.

Restore Path

From the customer perspective:

Customer connects to Doyenz application website

Customer selects machine to restore

Customer clicks restore and after some amount of time, machine is restored.

Customer has VNC connection with restored machine.

Technical implications:

Doyenz will need to spin up the appropriate 3RD PARTY STORAGE APPLIANCE and a 3rd Party instance to perform the restore.

Doyenz will have to make the restore in several steps (in addition to the standard routing issues, etc.)
ccccc. B2V of the most recent full backup, system only
ddddd. Log into restored VM
eeeee. Perform an application, system incremental, and application incremental backup all at once.

ESX Stub Approach

Basic Approach

Customer server will reside a doyenz agent which will handle ESX VMDK generation, detect the change blocks, dedup to reduce size of transmission and upload the change blocks to the Doyenz data center. The change blocks will be applied to a VMDK which then gets stored for instant restore

Backup Path

From the Customer Perspective:

Customer installs the Doyenz agent.

Customers sets up the backup schedule—full and incremental backups

Customer enables simultaneous convert o esx vm on that schedule

Customer sets pre and post command to trigger our agent Customer needs to change malware detection policies to exclude Doyenz agent and/or 3RD PARTY—Needs investigation if this is needed

Customer may need doyenz agent with every beremote.exe which is likely to mean that it will need to reside on every machine. Pending investigation

The customer can use Doyenz web user interface to acces the cloud backups and/or perform test restores and fail-overs.

Technical Implications:

Doyenz agent will run a local web server which mocks vSphere API calls.

Customer starts 3rd Party incremental convert to ESX VM which the ESX stub intercepts and return proper responses to 3rd Party.
fffff. Intercepting vSphere API calls can be done using a web server
ggggg. Intercepting vStorage API calls can be done by hooking VDDK library.

Write requests to the vmdk will be de-dupped and written locally.

We will require buffer the writes to make sure we are only writing the final changes. Will require extra disk space on the client proportional to the change data size

May need extra memory requirements—need to investigate

Doyenz agent will upload the de-dupped

VM and apply to a VM stored in the cloud.

Restore Path

From the Customer Perspective:

Customer connects to Doyenz application website

Customer selects machine, backup and a restore point to restore

Customer clicks restore and after some amount of time, machine is restored.

Customer has VNC connection with restored machine.

Technical Implications:

We need a redup service that runs writes reduped blocks to a mounted VMDK

Step to Conform the VMX

Higher storage requirements than our existing ESX implementation. Guess is 10%. The arises as the blocks might be in different places and ZFS does not deal with that

Archiving needs to be adapted to handle consolidation

Failback—Option 1—VMDK, Option 2—Run 3rd Party and send them a 3RD PARTY BACKUP backup

Issues Encountered/Concerns

May be perceived invasive if we are replacing all ESX calls in runtime to go through a stub

Need to deal with fragility and complexity of the vSphere APIs

Need to deal with cases where customer has web server which listens on the same port

High cost in development and handling edge cases

If a incremental backup fails, 3rd Party will require a rebase. We need to understand how likely we are to cause an incremental to fail. This is likely even in the 3rd Party to 3RD PARTY STORAGE APPLIANCE case.

Hyper-V Approach

Basic approach

Customer server will reside a doyen agent that will use a hyper-V VHD generation to detect the change blocks, dedup to reduce size of transmission and upload the change blocks to the Doyenz data center. The change blocks will be applied to a VMDK which then gets stored and restored as a HIR instant restore

Backup Path

From the Customer Perspective:

Customer installs the Doyenz agent.

Customers sets up the backup schedule—full and incremental backups

Customer enables simultaneous convert to hyper-v vm on that schedule

Customer sets pre and post command to trigger our agent

Customer needs to change malware detection policies to exclude Doyenz agent and/or 3RD PARTY—Needs investigation if this is needed

The customer can use Doyenz web user interface to access the cloud backups and/or perform test restores and fail-overs.

Technical Implications:

Customer starts 3rd Party incremental convert to Hyper-V VM which the doyenz agent will intercept writes to the VHD.

Write requests to the vmdk will be de-dupped and written locally.

We will require buffer the writes to make sure we are only writing the final changes. Will require extra disk space on the client proportional to the change data size

May need extra memory requirements—need to investigate

Doyenz agent will upload the de-dupped

Blocks will be applied to a VM stored in the cloud.

Restore Path

From the Customer Perspective:

Customer connects to Doyenz application website

Customer selects machine, backup and a restore point to restore

Customer clicks restore and after some amount of time, machine is restored.

Customer has VNC connection with restored machine.

Technical Implications:

We need a redup service that runs writes reduped blocks to a mounted VMDK

Step to perform HIR

Step to create and conform the VM configurations

Higher storage requirements than our existing ESX implementation. Guess is 10%. The arises as the blocks might be in different places and ZFS does not deal with that

Archiving needs to be adapted to handle consolidation

Failback—Option 1—VMDK, Option 2—Run 3rd Party and send them a 3RD PARTY BACKUP backup

Issues Encountered/Concerns

Need to get the feature to work

Potentially bottleneck in file system interception—need to do it efficiently

High cost in development and handling edge cases

If a incremental backup fails, 3rd Party will require a rebase. We need to understand how likely we are to cause an incremental to fail. This is likely even in the 3rd Party to 3RD PARTY STORAGE APPLIANCE case.

vSphere Spoofing (for Example Using Public APIs)

Preparation steps.
1. It's require to hack Download Service to analyse http post/get command.
a. Download and apply the batch file under attachment
b. buildall.bat DownloadService
c. deployDownloadService.bat

The Download Service can act as a proxy to record all the traffic between 3rd Party and ESX.

2. copy a VM with 3RD PARTY installed, move that vm to any esx host, power it up, run 3RD PARTY, change the ESX address to your DownloadService. eg“10.20.11.12:30111”

Founding so far.

doGet command is hacked. A standard response of doGet is in ESXResponseTemplate

doPost:
2. RetrieveServiceContent is hacked, it returns the same response on every call.
3. Logout is hacked.
4. These command are preferably called in this order: CreateContainerView, CreateFilter, WaitForUpdateEx, DestroyPropertyFilter
5. Above sequence is called multiple times on each backup.
6. CreateContainerView is called slightly different. on (DataCenter, DataStore, VirtualMachine)
7. CreateContainerView preferably returns a session id.

Advise on further research.
8. Instead of analyzing the doGet/doPost alone, write a simple java class to call the vSphere api. Then compare the log file between 3RD PARTY and that temporary java class.

VSphere Agent

Goals

The goal is to integrate the VSphere agent with the ACU code base to leverage:

Server side configuration management

UploadService based uploads

DFT upload mechanic

Common code maintenance.

Components

The common backup worker currently used by the SP agent

A VSphere plugin, comprising:
hhhhh. A VSphere specific machine abstraction
iiiii. VSphere specific file transfer mechanic
jjjjj. Buffering to facilitate httpfiletransfer keepalive

A virtual machine to host the agent. Options under consideration:
kkkkk Windows—to leverage the existing C# updater
lllll. Linux—to leverage leverage free licensing and the lower disk space requirement

Configuration pages to handle the new VSphere configuration options

Design Considerations

The http file access is fragile, and the cost of losing it with ESX 4.1 and greater is high. We need to continuously explore other options, and design VSphere interaction with this fragility in mind.

VMDKs are usually very sparse, and we should consider this in the upload and in the LBS storage. This may involve detecting runs of zeros and marking them

Concurrence limitation can be important.

Example Solution Research

3RD PARTY Backups ideas

Upload 3RD PARTY backup files similar to SP backup files
mmmmm. Restore backups on demand using 3RD PARTY convert to ESX vmdk
nnnnn (or) Restore backups on demand using 3RD PARTY WinPE restore disk

Client side changed block detection
ooooo. vmdk approach—Configure 3RD PARTY to perform “convert to open vmdk” at the end of daily backup
   i. When backup convert completes—identify changed blocks from previous day vmdk
   ii. Main problem with this approach is how to perform diff of changed blocks. Couple of options to address that:
      1. Option 1: Perform a binary diff on the 2 files—expensive from 10 bandwidth and storage (research)
      2. Option 2: Identify changed blocks using 3rd party tools which can open 3RD PARTY backup files
      3. Option 3: Mount backup files and identify changed blocks using VSS snapshots—initial investigation turned out that this may be non-trivial since they use custom device snapshots which are not easily accesible
      4. Option 4: Mount backup files and identify changed files (and then blocks) by comparing NTFS MFTs
      5. Option 5: Detect mapping between backup files to blocks by mounting backup chain and detecting system io calls from it while reading the disk
      6. Option 6: User 3RD PARTY APIs to determine changed blocks (not sure if it even supports this)
ppppp. Detect changed blocks directly from 3RD PARTY backup files
   i. Using 3^{rd} party APIs/documentation about backup file structure
   ii. Trace reads from mounted backup files (research)
      1. Mount backup chain at last restore point
      2. Scan the mounted disk device block after block
      3. Intercepting block reads using a filesystem filter driver
      4. Map block read to chain files that were not uploaded
   iii. Mount latest backup chain and previous backup chain file and run binary diff on block level—
      1. pro: very reliable
      2. con: may be expensive from JO bandwidth point of view.
   iv. Mount only the latest backup chain and scan disk against previous md5 log of previous chain
qqqqq. Upload changed blocks only
rrrrr. Apply only changed blocks to zfs dataset mounted ESX vmdk on backend and take zfs snapshot—this takes care of consolidation (research)
sssss. When doing restore—perform necessary HIR operations
   i. Using SP restore HIR
   ii. By running HIR scripts on the mounted vmdk
ttttt. Boot vmdk in an Hypervisor:
   i. ESX—will require conversion to ESK vmdk for openvmdk approach mentioned above which is an expensive operation in terms of JO bandwidth
   ii. VirtualBox/VMWare Server/XEN—no current platform support for this—expensive from dev time

Concerns

Is a disk scanning on a customer like physical machine is fast enough?

Scanning mounted chain method may not be reliable. Is there a reliable way to detect the changed blocks consistently?

How many concurrent vddks mounts to vmdk can we maintain on a single box?

Thoughts on Block Hash Lookup Index

I′d first like to say that I don't think this is a must for 3RD PARTY since the signature file could be sufficient (although sub optimal) initial phase. The lookup which is used for the “d-sync” could be added later without changing the backend given the current design. It will certainly be a must for 3rd Party Windows agent.

So there are couple of approaches I was thinking about but probably none is simple in terms of development effort.

The requirement is to be able to do fast lookup of block offset given an md5 hash.

Data structures to support that:
1. B+Tree or a just use a database which effectively creates a B/B+tree on a table index.
2. Disk based hash table—flat file with hash collision buckets at constant offsets which should be resized when a bucket gets full. The file should be mmap-ed for better performance.

B-tree drawback is that is suffer from fragmentation for the type of data we intend to use. A mitigation strategy for this is creating pages with small fill factor which should reduce fragmentation till pages start to get full. The hash table suffers from the need for rehashing when buckets get full. So essentially both solutions suffer from similar problem and the choice should most likely be based on ease of implementation.

The idea is as follows (assuming index structure was selected):
3. Create an empty index
4. Insert/lookup index during backup
5. If need rebuild parts of the index while waiting for chunk upload to complete or rebuild all if must.
6. On the post backup signature processing—while rebuilding the new signature from repopulate the index with big fill factor so it would be ready for next backup.

If index get corrupted/missing—it can be rebuilt from the signature file like in step 4.

An optimization would be seed an index at the backend with known blocks for target OS/apps and send to client before backup start. This might have potential to reduce initial upload size by 10-20 GB per server.

We can consider thinking if there is a similar data structure or enhancement to the current 2 options which will allow partial rebuilding of the index instead of full rebuild every time it is needed.

While a preferred embodiment of the invention has been illustrated and described, as noted above, many changes can be made without departing from the spirit and scope of the invention. Instead, the invention should be determined entirely by reference to the claims that follow.

The embodiments of the invention in which an exclusive property or privilege is claimed are defined as follows:

1. A system comprising elements described above herein.

2. A method comprising steps described above herein.
